(19) United States
(12) Patent Application Publication
(10) Pub. No.: US 2026/0083134 A1
(43) Pub. Date: Mar. 26, 2026

(54) MEANS AND METHODS FOR CONTROLLING PATHOGENS AND PESTS IN PLANTS

(71) Applicants: APHEA.BIO NV, Zwijnaarde (BE); FUNDACIÓN CENTRO DE EXCELENCIA EN INVESTIGACIÓN DE MEDICAMENTOS INNOVADORES EN ANDALUCÍA, MEDINA, Granada (ES)

(72) Inventors: Emma LAGAE, Afsnee (BE); Thomas SIMON, Zwijnaarde (BE); Isabel VERCAUTEREN, Herzele (BE); Steven VANDENABEELE, Oudenaarde (BE); Frederik ROELS, Sint-Denijs-Wes (BE); Jens MAINTZ, Zwijnaarde (BE)

(21) Appl. No.: 18/021,926

(22) PCT Filed: Aug. 18, 2021
(86) PCT No.: PCT/EP2021/072925

§ 371 Date: Feb. 17, 2023

(30) Foreign Application Priority Data
Aug. 18, 2020 (EP) 20191492.6

(51) Int. Cl. A01N 63/20; A01P 3/00

(52) U.S. Cl. CPC A01N 63/20; A01P 3/00

(57) ABSTRACT

The current invention relates to a purified bacterial strain suitable for controlling a pest or pathogen in a plant, said strain comprises at least one 16S nucleotide sequence that is at least 99.7% identical to SEQ ID NO: 1. The present invention also relates to a purified bacterial strain comprising at least one 16S nucleotide sequence that is at least 99% identical to SEQ ID NO:1, wherein said strain comprises in its genomic DNA at least one sequence that is at least 95% identical to a sequence chosen from SEQ ID NO: 3 to 12. The current invention also relates to an agricultural active formulation comprising a purified bacterial strain, and to the use of such purified bacterial strain. In addition, the present invention relates to a method of controlling a pest or pathogen in plants.

### CROSS-REFERENCE TO RELATED APPLICATIONS

This application is a National Stage Entry of PCT/EP2021/072925, filed Aug. 18, 2021, which claims priority to European Application No. 20191492.6, filed Aug. 18, 2020, the disclosures of each of which are hereby incorporated by reference in their entirety.

### REFERENCE TO ELECTRONIC SEQUENCE LISTING

The application contains a Sequence Listing which has been submitted electronically in .TXT format and is hereby incorporated by reference in its entirety. Said .TXT file, created on Sep. 26, 2023, is named “044543_00001-Replacement_Sequence_Listing-ST25” and is 20094 bytes in size. The sequence listing contained in this .TXT file is part of the specification and is hereby incorporated by reference herein in its entirety.

### FIELD OF THE INVENTION

The present invention relates to the field of pest and pathogen control and resistance in plants using bacteria. The present invention discloses both means and methods for controlling these pests and pathogens.

### BACKGROUND

There is a continuous increase in the demand for agricultural products, in order to be able to feed the growing human population as well as the cattle. In addition, such growing demand puts a further strain on the environment, because of the conventional practices used in agriculture. The most serious problem encountered in the cultivation of crops is the loss of material and damage caused by harmful plant pathogens.

Various methods have been developed so far to control plant diseases and pests. Among them, the most commonly used and the most developed method is the chemical control method using chemical pesticides. Chemical pesticides are convenient to use and have immediate effects to protect plants from pathogenic infections, but are listed as specified poisonous substances, poisonous substances, deleterious substance, etc., which are regulated by law. In recent years, the abuse of chemical pesticides have created social problems: intoxications and deaths caused by acute toxicity; contamination of food due to residual pesticides in agricultural products; and influence of the outflow of residual pesticides on the human body and environment. Furthermore, new pathogens and pests resistant to previous chemical pesticides are emerging, forcing the development of new types of pathogen control, creating an endless cycle.

A promising practice is the use of microorganisms for battling and controlling pathogenic plant infections and disease symptoms. U.S. Pat. No. 7,037,879 for instance describes the use of endophytic bacteria for conferring pest resistance to grass plants. Plants infected with microorganisms have the above-mentioned resistance conferred by the endophytes. Therefore, no pesticides are required for cultivating these plants, which means that prevention is possible no matter what pathogenic occurrences have been predicted.

There is however a further need in the market for other bio-based pathogen and pest control methods and means, preferably broad-spectrum methods that are not harmful for the environment, the host, and the consumer. The current invention aims to provide a solution for the latter.

### SUMMARY OF THE INVENTION

The present invention and embodiments thereof serve to provide a solution to one or more of above-mentioned disadvantages. To this end, the present invention relates to a purified bacterial strain suitable for controlling a pest or pathogen in a plant. In an embodiment according to claim 1, said strain comprises at least one 16S nucleotide sequence that is at least 99% identical to SEQ ID NO:1. Said strain further comprises in its genomic DNA at least one sequence that is at least 95% identical, preferably at least 98% identical to a sequence chosen from SEQ ID NO: 3 to 12. In an embodiment according to claim 2, the present invention relates to a purified bacterial strain suitable for controlling a pest or pathogen in a plant. In particular, said strain comprises at least one 16S nucleotide sequence that is at least 99.7% identical to SEQ ID NO:1. In an embodiment according to claim 5, the present invention relates to a purified bacterial strain suitable for controlling a pest or pathogen in a plant. In particular, said strain comprises at least one 16S nucleotide sequence that is at least 99% identical to SEQ ID NO:1, and said strain produces albofungin. Preferred embodiments of the bacterial strains according to claims 1, 2 and/or 5 are shown in any of the claims 3 to 4 and 6 to 15.

In a second aspect, the present invention relates to an agricultural active formulation comprising a purified bacterial strain, or comprising a microbial active ingredient derived from said bacterial strain as active ingredient, according to claim 16.

In a third aspect, the present invention relates to the use of the purified bacterial strain or the agricultural formulation to control a pest or pathogen in plants, according to claim 18.

In a final aspect, the present invention relates to a method of controlling a pest or pathogen in plants according to claim 19. Preferred embodiments of the method are show in any of the claims 20 to 22.

### Definitions

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

The recitation of numerical ranges by endpoints includes all numbers and fractions subsumed within that range, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

The term “pathogen” as used herein relates to a causative agent of disease. Such causative agent can be, amongst others, a microorganism such as a virus, a bacterium or a fungi. The term “pest” or “plant pest” refers to a destructive insect or other animal that attacks and (partially) destroys plants. Most important plant pests are insects, mites, nematodes and gastropod molluscs. Plant pests may also transmit fungal, bacterial or viral infections. As used herein, pathogen and pest may be used interchangeably and may refer to both pathogens and pests as defined before.

The term “soil sourced” relates to an organism that originally originates from the soil, preferably from the root environment of plants and were sourced from the latter. Soil sourced organisms such as bacteria may then be further cloned or propagated in an environment outside their initial environment, such as a laboratory environment.

As used herein, the term “microorganism” or “microbe” refers to any species or taxon of microorganism, including, but not limited to, archaea, bacteria, microalgae, fungi (including mold and yeast species), mycoplasmas, microspores, nanobacteria, oomycetes, and protozoa. In some embodiments, a microbe or microorganism encompasses individual cells (e.g., unicellular microorganisms) or more than one cell (e.g., multi-cellular microorganism).

As used herein, the term “bacterium”, “bacteria”, or “bacterial” refers in general to any prokaryotic organism, and may reference an organism from either Kingdom Eubacteria (Bacteria), Kingdom Archaebacteria (Archaea), or both. In some cases, bacterial genera have been reassigned due to various reasons (such as, but not limited to, the evolving field of whole genome sequencing), and it is understood that such nomenclature reassignments are within the scope of any claimed genus.

The term “16S nucleotide sequence” or “16S” refers to the DNA sequence of the 16S ribosomal RNA (rRNA) sequence of a bacterium. 16S rRNA gene sequencing is a well-established method for studying phylogeny and taxonomy of bacteria. A full length 16S nucleic acid sequence counts for approximately 1500 nucleotides in length.

The term “purified” is intended to specifically reference an organism, cell, tissue, polynucleotide, or polypeptide that is removed from its original source. The term “purified” does not necessarily reflect the extent to which the microbe has been purified. As used herein, a “purified bacteria” or “purified bacterial strain” is a bacterial strain that has been removed from its natural milieu. The term “purified bacterial strain” refers to substantially no other strains than the desired strain, and is therefore substantially free of other contaminants, which can include microbial contaminants. Further, as used herein, “purified bacterial strain” is intended to mean the strain separated from materials with which it is normally found in nature.

The terms “identity” or “identical”, or “similarity” or “similar” in the context of nucleotide sequences refer to the nucleotides in the two sequences that are the same when aligned for maximum correspondence. There are different algorithms known in the art that can be used to measure nucleotide sequence identity. Nucleotide sequence identity can be measured by a local or global alignment, preferably implementing an optimal local or optimal global alignment algorithm. For example, a global alignment may be generated using an implementation of the Needleman-Wunsch algorithm. For example, a local alignment may be generated using an implementation of the Smith-Waterman algorithm.

A gap is a region of an alignment wherein a sequence does not align to a position in the other sequence of the alignment. In global alignments, terminal gaps are discarded before identity is calculated. For both local and global alignments, internal gaps are counted as differences. A terminal gap is a region beginning at the end of a sequence in an alignment wherein the nucleotide in the terminal position of that sequence does not correspond to a nucleotide position in the other sequence of the alignment and extending for all contiguous positions in that sequence wherein the nucleotides of that sequence do not correspond to a nucleotide position in the other sequence of the alignment.

A “plant element” or “plant part” is intended to generically reference either a whole plant or a plant component, including but not limited to plant tissues, parts, and cell types. A plant element is preferably one of the following: whole plant, seedling, meristematic tissue, ground tissue, vascular tissue, dermal tissue, seed, leaf, root, shoot, stem, flower, ear, spike, spikelet, fruit, stolon, bulb, tuber, corm, keikis, bud. As used herein, a “plant element” is synonymous to a “portion” of a plant, and refers to any part of the plant, and can include distinct tissues and/or organs, and may be used interchangeably with the term “tissue” throughout. In addition, a “plant element” is intended to generically reference any part of a plant that is able to initiate other plants via either sexual or asexual reproduction of that plant, for example but not limited to: seed, seedling, root, shoot, cutting, scion, graft, stolon, bulb, tuber, corm, keikis, or bud.

“Agricultural plants” or “plants of agronomic importance” include plants that are cultivated by humans for food, feed, fiber, fuel, and/or industrial purposes. In some embodiments, plants (including seeds and other plant elements) treated in accordance with the present invention are monocots. In a particular embodiment, the agricultural plant is selected from the group consisting of wheat (Triticum aestivum and related varieties), barley (Hordeum vulgare and related varieties) or maize (Zea mays and related varieties).

An “active formulation” refers to a mixture of chemicals that facilitate the stability, storage, and/or application of the bacterial strain(s). Treatment formulations may comprise any one or more agents such as: a carrier, a solvent, an adjuvant, an oil, an emulsifier, a spreader, a cryoprotectant, a binder, a dispersant, a surfactant, a buffer, a tackifier, a microbial stabilizer, a fungicide, a complexing agent, an herbicide, a nematicide, an insecticide, a plant growth regulator, a rodenticide, a desiccant, a nutrient, an excipient, a wetting agent, or a salt.

As used herein an “agriculturally compatible carrier” or “agriculturally compatible excipient” refers to any material, other than water, that can be added to a plant element without causing or having an adverse effect on the plant element (e.g., reducing seed germination) or the plant that grows from the plant element, or the like.

As used herein, a “colony-forming unit” or “CFU” is used as a measure of viable microorganisms in a sample. A CFU is an individual viable cell capable of forming on a solid medium a visible colony whose individual cells are derived by cell division from one parental cell.

The term “supernatant” refers to the liquid broth remaining when cells grown in said broth are removed by centrifugation, filtration, sedimentation or other means well known in the art.

The term “extract” refers to various forms of microbial products. Said microbial products are obtained by removing the cell walls and/or cell membranes of the bacterial strains, a process known as lysis, thereby obtaining one or more endogenous products of the bacterial strains in culture.

### DESCRIPTION OF FIGURES

The following description of the figures of specific embodiments of the invention is merely exemplary in nature and is not intended to limit the present teachings, their application or uses.

FIGS. 1A-1B show templates used in co-culturing experiments with pathogenic fungi (FIG. 1A) and with a pathogenic bacterium (FIG. 1B).

FIGS. 2A-2D show a graphical representation of the disease severity (%) of wheat plants upon inoculation with the fungal pathogen Fusarium graminearum (Fg) compared to inoculation with Fg and an isolated bacterial strain according to the present invention, and compared to Mock treated wheat plants. Bacterial strain with Deposit ID B/00234 (FIG. 2A); B/00233 (FIG. 2B); B/00309 (FIG. 2C) and B/00235 (FIG. 2D).

FIG. 3 shows a graphical representation of the disease severity (%) of wheat plants upon inoculation with the fungal pathogen Puccinia striiformis var. tritici (Pst) compared to inoculation with Pst and an isolated bacterial strain according to the present invention with deposit ID B/00234.

FIG. 4 shows a graphical representation of the disease severity (%) of wheat plants upon inoculation with the fungal pathogen Zymoseptoria tritici (Zt) compared to inoculation with Zt and an isolated bacterial strain according to the present invention with Deposit ID B/00234, and compared to Mock treated wheat plants.

FIGS. 5-10 show LC-UV (210 nm) chromatograms of extract fractions (FIGS. 5A, 6A, 7A, 8A, 9A and 10A) and mass spectra of said fractions (FIGS. 5B, 6B, 7B, 8B, 9B and 10B), said fractions are of fermentation broths of purified bacterial strains with Deposit IDs B/00233, B/00234, B/00235 and B/00309. If the spectra show multiple peaks, the relevant peak has been marked.

### DEPOSIT INFORMATION

The bacterial strains of current invention are deposited with the Polish Collection of Microorganisms, under the terms of the Budapest Treaty with Deposit ID: B/00234, B/00233, B/00235 and B/00309.

### DETAILED DESCRIPTION OF THE INVENTION

The present invention concerns means and methods for controlling pests and/or pathogen in plants.

In an embodiment, the present invention relates to a purified bacterial strain suitable for controlling a pest or a pathogen in a plant. In particular, said strain comprises at least one 16S nucleotide sequence that is at least 99.7% identical to SEQ ID NO:1.

It was found that strains having a 16S rRNA sequence showing at least 99.7% identity with SEQ ID NO:1 exhibited a strong activity against various pathogens and pests when being used in plants. As a consequence, said strains can be used for pest and/or pathogen control in plants.

In an embodiment, said strain comprises at least one 16S nucleotide sequence that is at least 99.8%, more preferably 99.9%, or 100% identical to SEQ ID NO:1.

In an embodiment, said strain comprises at least one 16S nucleotide sequence with a sequence according to SEQ ID NO:1 or SEQ ID NO:2.

The strains according to one or more of the embodiments described above are specifically useful for the control of pest and/or pathogens in a plant. To that purpose, said strains may be applied to the plant or part of said plants as described below. In a particular preferred embodiment, said plant is Triticum, Secale, Hordeum or Avena. In an embodiment, said pests or pathogen may be any Eukaryotic or Prokaryotic pathogen or pests, such as but not limited to viral, bacterial, fungal pathogens or insect pests, as further described below. It will be understood that embodiments as described below, specifically with regard to gene sequences SEQ ID NO 3 to 19 may equally apply to the strain having a 16S rRNA sequence showing at least 99.7% identity with SEQ ID NO:1.

In another embodiment, the present invention relates to a purified bacterial strain suitable for controlling a pest or pathogen in a plant. In particular, said strain comprises at least one 16S nucleotide sequence that is at least 99% identical to SEQ ID NO: 1. Further, said strain comprises in its genomic DNA at least one sequence that is at least 95% identical, preferably 98% identical to a sequence chosen from SEQ ID NO: 3 to 12.

Upon analysis it was found that sequences with a sequence similar to SEQ ID NO: 3 to 12 relate to genes or partial genes known to be associated with gene clusters encoding for enzymes and regulatory genes that are linked to the production of specific classes of secondary metabolites. Secondary metabolites are to be defined as small organic compounds produced by an organism which are not essential for their growth, development and reproduction. Secondary metabolites are known to play a role in various activities and functions of microorganisms, such as protection, competition and interactions. The genes and sequences currently identified are all known to be part of gene clusters related to the inhibition and/or killing of pathogens and/or pests.

Without wishing to be bound to any theory, it is believed that at least one of said identified sequences plays a role in the observed activity of said strains of the current invention.

Each SEQ ID and related metabolite/compound is described further below.

SEQ ID NO: 3 relates to a gene sequence associated with the production of albonoursin. Albonoursin is an antibacterial diketopiperazine peptide. Diketo-piperazines are simple cyclic peptides.

SEQ IDs NO: 4 to 6 all relate to gene sequences associated with methylstreptimidone production. Methylstreptimidone, also referred to as 9-methyl-streptimidone, is an antibiotic compound of the glutarimide group of antibiotics, with known high antifungal and anti-yeast activity.

SEQ ID NO: 7 relates to a gene sequence associated the production of puromycin. Puromycin is an aminonucleoside antibiotic protein synthesis inhibitor which causes premature chain termination during translation in the ribosome, both in prokaryotic and eukaryotic cells.

SEQ ID NO: 8 relates to a gene sequence associated with thiazostatin and/or watasemycin production. Both compounds are structurally very alike. The only difference is that watasemycin possesses a methyl group at 5′-position of thiazostatin instead of a hydrogen atom. Watasemycins exhibits antibiotic activity against gram-positive and gram-negative bacteria and yeast.

SEQ IDs NO: 9 to 12 relate to gene sequences associated with the production of xantholipin. Xantholipin is a polycyclic xanthone antibiotic that exhibits potent cytotoxic and antibacterial activity. In addition, said gene sequences are associated with the production of further polycyclic xanthone antibiotics. Family members of the polycyclic xanthone antibiotics are known to exhibit diverse biological activities, such as antibiotics, antifungal, anthelmintic, and potent antitumor activity. Albofungin is a family member of the polycyclic xanthone antibiotics, the latter also showing antimicrobial activity.

It was found that strains having a 16S rRNA sequence showing identity with SEQ ID NO:1 and at least one of the genomic sequences as described above, exhibited an exceptional activity against various pathogens and pests when being used in plants. As a consequence, said strains can be used for pest and/or pathogen control in plants.

In an embodiment, said strain produces albofungin. Strains producing albofungin are particularly effective in controlling a pest or pathogen in a plant.

In another or further embodiment, said strain further produces one or more metabolites selected from the group of streptimidone, N-myristylamidopropyl-N,N-dimethylbetaine, pimaricin, enactin Ia/Ib and lauramidopropyl betaine.

Streptimidone, is an antibiotic compound of the glutarimide group of antibiotics, with known high antifungal and anti-yeast activity.

Both N-myristylamidopropyl-N,N-dimethylbetaine and Lauramidopropyl betaine are members of the betaine family of compounds that have antistatic and viscosity-increasing characteristics.

Pimaricin, also known as natamycin, is an amphoteric macrolide antifungal antibiotic, commonly used to treat fungal infections around the eye, including infections of the eyelids, conjunctiva, and cornea, usually in the form of eye drops. Natamycin is also used in the food industry as a preservative.

Enactin Ia/Ib, is related to Neo-enactin. Both compounds are known as a potentiator for polyene antifungal antibiotics, acting by inhibition of N-myristoyltransferase (NMT). NMT is a key cellular enzyme which carries out lipid modification by facilitating the attachment of myristate to the N-terminal glycine of several protein molecules. The enzyme's function is indispensable for the growth and development of many organisms.

In an embodiment, said strain further produces at least two, at least three, at least four, at least all five of the metabolites selected from the group of streptimidone, N-myristylamidopropyl-N,N-dimethylbetaine, pimaricin, enactin Ia/Ib and lauramidopropyl betaine.

In a preferred embodiment, said purified bacterial strain comprises at least one 16S nucleotide sequence that is at least 99% identical to SEQ ID NO:1, and said strain produces albofungin. More preferably, said strain produces one or more metabolites selected from streptimidone, N-myristylamidopropyl-N,N-dimethylbetaine, pimaricin, enactin Ia/Ib and lauramidopropyl betaine.

Preferably said strain comprises at least one 16S nucleotide sequence that is at least 99.1% identical, more preferably at least 99.2% identical, more preferably at least 99.3% identical, more preferably at least 99.4% identical, more preferably at least 99.5% identical, more preferably at least 99.6% identical, more preferably at least 99.7% identical, more preferably at least 99.8% identical, more preferably at least 99.9%, most preferably 100% identical to SEQ ID NO:1.

It was shown that bacterial strains comprising:
at least one 16S nucleotide sequence that is at least 99% identical to SEQ ID NO:1, and that comprises in its genomic DNA at least one sequence that is at least 95% identical to a sequence chosen from SEQ ID NO: 3 to 12; or
at least one 16S nucleotide sequence that is at least 99.7% identical to SEQ ID NO:1;
and produces albofungin, and preferably further produces one or more metabolites selected from the group of streptimidone, N-myristylamidopropyl-N,N-dimethylbetaine, pimaricin, enactin Ia/Ib and lauramidopropyl betaine, are particularly effective in controlling a pest or pathogen in a plant.

In an embodiment, said strain comprises at least one 16S nucleotide sequence that is at least 99.1%, more preferably at least 99.2%, more preferably 99.3%, more preferably at least 99.4%, more preferably 99.5%, more preferably at least 99.6%, more preferably 99.7%, more preferably at least 99.8%, more preferably 99.9% identical to SEQ ID NO:1.

In an embodiment, said strain comprises at least one 16S nucleotide sequence with a sequence according to SEQ ID NO:1 or SEQ ID NO:2.

In an embodiment, said strain comprises in its genomic DNA at least one sequence, that is at least 95% identical, preferably at least 95.5% identical, more preferably at least 96% identical, more preferably at least 96.5% identical, more preferably at least 97% identical, more preferably at least 97.5% identical, more preferably at least 98% identical, more preferably at least 98.5% identical, more preferably at least 99% identical, more preferably at least 99.1% identical, more preferably at least 99.2% identical, more preferably at least 99.3% identical, more preferably at least 99.4% identical, more preferably at least 99.5% identical, more preferably at least 99.6% identical, more preferably at least 99.7% identical, more preferably at least 99.8% identical, more preferably at least 99.9%, most preferably 100% identical to a sequence chosen from SEQ ID NO: 3 to 12.

In an embodiment, said strain comprises in its genomic DNA at least two sequences, preferably at least three sequences, more preferably at least four sequences, more preferably at least five sequences, more preferably at least six sequences, more preferably at least seven sequences, more preferably at least eight sequences, more preferably at least nine sequences, most preferably at least ten sequences that are at least 95% identical, preferably at least 95.5% identical, more preferably at least 96% identical, more preferably at least 96.5% identical, more preferably at least 97% identical, more preferably at least 97.5% identical, more preferably at least 98% identical, more preferably at least 98.5% identical, more preferably at least 99% identical, more preferably at least 99.1% identical, more preferably at least 99.2% identical, more preferably at least 99.3% identical, more preferably at least 99.4% identical, more preferably at least 99.5% identical, more preferably at least 99.6% identical, more preferably at least 99.7% identical, more preferably at least 99.8% identical, more preferably at least 99.9%, most preferably 100% identical to a sequence chosen from SEQ ID NO: 3 to 12.

In another or further preferred embodiment, said bacterial strain produces albofungin and comprises in its genomic DNA gene sequences identical to each of sequences with SEQ ID NO: 9 to 12.

In a most preferred embodiment, said bacterial strain comprises in its genomic DNA sequences which are at least 98% identical, more preferably at least 98.1% identical, more preferably at least 98.2% identical, more preferably at least 98.3% identical, more preferably at least 98.4% identical, more preferably at least 98.5% identical, more preferably at least 98.6% identical, more preferably at least 98.7% identical, more preferably at least 98.8% identical, more preferably at least 98.9% identical, more preferably at least 99% identical, more preferably at least 99.1% identical, more preferably at least 99.2% identical, more preferably at least 99.3% identical, more preferably at least 99.4% identical, more preferably at least 99.5% identical, more preferably at least 99.6% identical, more preferably at least 99.7% identical, more preferably at least 99.8% identical, more preferably at least 99.9%, most preferably 100% identical to each of the sequences with SEQ ID NO: 3 to 12.

In addition, upon analysis it was found that sequences with a sequence similar to SEQ ID NO: 15 to 19 also relate to genes or partial genes known to be associated with gene clusters encoding for enzymes and regulatory genes that are linked to the production of specific classes of secondary metabolites. The genes and sequences currently identified are all known to be part of gene clusters related to the inhibition and/or killing of pathogens and/or pests.

In an embodiment, said strain comprises in its genomic DNA further also at least one sequence that is at least 95% identical, preferably at least 95.5% identical, more preferably at least 96% identical, more preferably at least 96.5% identical, more preferably at least 97% identical, more preferably at least 97.5% identical, more preferably at least 98% identical, more preferably at least 98.5% identical, more preferably at least 99% identical, more preferably at least 99.1% identical, more preferably at least 99.2% identical, more preferably at least 99.3% identical, more preferably at least 99.4% identical, more preferably at least 99.5% identical, more preferably at least 99.6% identical, more preferably at least 99.7% identical, more preferably at least 99.8% identical, more preferably at least 99.9%, most preferably 100% identical to a sequence chosen from SEQ ID NO: 15 to 19.

Sequences relating to SEQ ID NO: 15 to 19 also relate to gene sequences known to be associated with enzymes and regulatory genes that produce specific classes of secondary metabolites. Each SEQ ID and related metabolite/compound is described further below.

SEQ ID NO: 15 relates to a gene sequence associated with the production of nystatin. Nystatin is an ionophore (a chemical species binding reversibly to ions), belonging to the polyene macrolide antibiotics and binding to ergosterol, a major component of the fungal cell membrane, where it—when present in sufficient concentrations—forms pores in the membrane that lead to K+ leakage, acidification, and death of the fungus.

SEQ ID NO: 16 relates to a gene sequence associated with paenibactin production. Paenibactin is a siderophore, which is a small, high-affinity iron-chelating compound that is secreted by microorganisms such as bacteria and fungi and serves primarily to transport iron across cell membranes. Siderophores are among the strongest soluble Fe3+ binding agents known. Many (pathogenic) bacteria produce and secrete siderophores, which serve as iron scavengers to meet iron limitation by sequestering iron from the host.

SEQ ID NO: 17 relates to a gene sequence associated with the production of paromomycin. Paromomycin belongs to the aminoglycoside antibiotics and is a protein synthesis inhibitor in nonresistant cells by binding to 16S ribosomal RNA. Paromomycin works as a broad-spectrum antibiotic by increasing the error rate in ribosomal translation.

SEQ ID NO: 18 relates to a gene sequence associated with cyclothiazomycin production. Cyclothiazomycins B and C both are thiopeptide antibiotics and exhibit antibacterial activity, at least against Gram-positive bacteria.

SEQ ID NO: 19 relates to a gene sequence associated with the production of mannopeptimycin. Mannopeptimycins are glycopeptide antibiotics that are active against a wide variety of gram-positive bacteria, such as by act by targeting cell wall biosynthesis.

In an embodiment, said strain comprises in its genomic DNA at least two sequences, preferably at least three sequences, more preferably at least four sequences, most preferably at least five sequences that are at least 95% identical, preferably at least 95.5% identical, more preferably at least 96% identical, more preferably at least 96.5% identical, more preferably at least 97% identical, more preferably at least 97.5% identical, more preferably at least 98% identical, more preferably at least 98.5% identical, more preferably at least 99% identical, more preferably at least 99.1% identical, more preferably at least 99.2% identical, more preferably at least 99.3% identical, more preferably at least 99.4% identical, more preferably at least 99.5% identical, more preferably at least 99.6% identical, more preferably at least 99.7% identical, more preferably at least 99.8% identical, more preferably at least 99.9%, most preferably 100% identical to a sequence chosen from SEQ ID NO: 15 to 19.

In a specifically preferred embodiment, said bacterial strain comprises in its genomic DNA sequences which are at least 98% identical, more preferably at least 98.5% identical, more preferably at least 99% identical, more preferably at least 99.1% identical, more preferably at least 99.2% identical, more preferably at least 99.3% identical, more preferably at least 99.4% identical, more preferably at least 99.5% identical, more preferably at least 99.6% identical, more preferably at least 99.7% identical, more preferably at least 99.8% identical, more preferably at least 99.9%, most preferably 100% identical to each of the sequences with SEQ ID NO: 4 to 13, and which are at least 98% identical, more preferably at least 98.5% identical, more preferably at least 99% identical, more preferably at least 99.1% identical, more preferably at least 99.2% identical, more preferably at least 99.3% identical, more preferably at least 99.4% identical, more preferably at least 99.5% identical, more preferably at least 99.6% identical, more preferably at least 99.7% identical, more preferably at least 99.8% identical, more preferably at least 99.9%, most preferably 100% identical to each of the sequences with SEQ ID NO: 15 to 19.

In a specifically preferred embodiment, said bacterial strain comprises in its genomic DNA sequences with are 100% identical to each of the sequences SEQ ID NO: 3 to 12 and SEQ ID NO: 15 to 19.

In an embodiment, said strain further comprises in its genomic DNA at least one sequence that is at least 95% identical, preferably at least 99% identical to a sequence chosen from SEQ ID NO: 13 to 14.

Sequences relating to SEQ ID NO: 13 to 14 relate to gene sequences known to be associated with enzymes and regulatory genes that produce specific classes of secondary metabolites. Each SEQ ID and related metabolite/compound is described further below.

SEQ ID NO: 14 to 15 relate to gene sequences associated with phosphonate production. A number of natural product phosphonate substances with antibiotic properties have been identified. Natural product phosphonate antibiotics are effective against a number of organisms. As an example, many bacterial species express glycerol-3-phosphate and glucose-6-phosphate importers, which can be hijaked by phosphonate antibiotics.

In an embodiment, said strain comprises in its genomic DNA at least one sequence, preferably at least two sequences that is/are at least 95% identical, preferably at least 95.5% identical, more preferably at least 96% identical, more preferably at least 96.5% identical, more preferably at least 97% identical, more preferably at least 97.5% identical, more preferably at least 98% identical, more preferably at least 98.5% identical, more preferably at least 99% identical, more preferably at least 99.1% identical, more preferably at least 99.2% identical, more preferably at least 99.3% identical, more preferably at least 99.4% identical, more preferably at least 99.5% identical, more preferably at least 99.6% identical, more preferably at least 99.7% identical, more preferably at least 99.8% identical, more preferably at least 99.9%, most preferably 100% identical to a sequence chosen from SEQ ID NO: 13 to 14.

It is understood that screening for sequences as described in embodiments above in strains, together with metabolite screening allows for the identification of additional strains conform the current invention. Techniques for screening of sequences and for screening of metabolites are generally known in the art.

In an embodiment, a reference of said purified bacterial strain is deposited with the Polish Collection of Microorganisms, respectively as Deposit ID: B/00234, B/00233, B/00235 or B/00309. In another embodiment, said strain is a mutant of a strain deposited under B/00234, B/00233, B/00235 or B/00309, said mutant is still capable of controlling a pest or a pathogen in a plant. In yet another embodiment, said strain is a strain with at least 98%, more preferably at least 98.1%, more preferably at least 98.2%, more preferably at least 98.3%, more preferably at least 98.4%, more preferably at least 98.5%, more preferably at least 98.6%, more preferably at least 98.7%, more preferably at least 98.8%, more preferably at least 98.9%, more preferably at least 99%, more preferably at least 99.1%, more preferably at least 99.2%, more preferably at least 99.3%, more preferably at least 99.4%, more preferably at least 99.5%, more preferably at least 99.6%, more preferably at least 99.7%, more preferably at least 99.8%, more preferably at least 99.9% genomic sequence identity with a bacterial strain as deposited as Deposit ID: B/00234, B/00233, B/00235 or B/00309 and still capable of controlling a pest or pathogen in a plant.

Said mutant of said deposited strains and/or said strain having a specific amount of genomic sequence identity with said deposited bacterial strain, which is still capable of controlling a pest or a pathogen, is preferably capable to control said pest or said pathogen in a manner similar as the deposited strains B/00234, B/00233, B/00235 or B/00309.

Preferably, said mutant of said deposited strains and/or said strain having a specific amount of genomic sequence identity with said deposited bacterial strain, still produces albofungin.

Preferably said mutant of said deposited strains and/or said strain having a specific amount of genomic sequence identity with said deposited bacterial strain further still produces one or more metabolites selected from the group of streptimidone, N-myristylamidopropyl-N,N-dimethylbetaine, pimaricin, enactin Ia/Ib and lauramidopropyl betaine.

In an embodiment, purified bacterial strains with Deposit ID: B/00234, B/00233, B/00235 or B/00309 comprise at least one 16S nucleotide sequence that is identical to SEQ ID NO: 1.

The strains according to one or more of the embodiments described above are specifically useful for the control of pest and/or pathogens in a plant. To that purpose, said strains may be applied to the plant or part of said plants as described below. In a particular preferred embodiment, said plant is Triticum, Secale, Hordeum or Avena. In an embodiment, said pests or pathogen may be any Eukaryotic or Prokaryotic pathogen or pests, such as but not limited to viral, bacterial, fungal pathogens or insect pests, as further described below.

In a second aspect, the present invention relates to an agricultural active formulation or composition comprising a purified bacterial strain, or comprising a microbial active ingredient derived from said bacterial strain as active ingredient, said formulation is suitable to be used as a pest or pathogen control agent for plants, wherein said bacterial strain is a purified bacterial strain as defined above in any of the previous embodiments.

Non-limiting examples of said agricultural active formulation or composition are soluble powders, soluble granules, wettable granules, tablet formulations, dry flowables, aqueous flowables, wettable dispersible granules, oil dispersions, suspension concentrates, dispersible concentrates, emulsifiable concentrates, aqueous suspensions, a fertilizer granule, or a sprayable.

In an embodiment of the formulation or composition, said purified bacterial strain is present at a concentration of at least about 10² CFU, cells or spores/ml in a liquid formulation; or at least about 10² CFU, cells or spores/mg in a non-liquid formulation. As non-limiting example, said cells may be living cells or spray-dried cells. Such enhanced concentrations of said bacterial strains are not found in nature. The bacterial strains have been propagated until they reached said concentrations.

In another or further embodiment, said formulation or composition comprises one or more bacterial strains as disclosed herein as a mixture. In an embodiment, said formulation comprises at least 2, at least 3 or at least 4 bacterial strains as disclosed herein or any suitable mixture. Said combination of strains preferably has a synergistic effect in controlling (a) pest(s) or pathogen(s) in a plant.

In an embodiment said agricultural active formulation or composition further comprises at least one oil, surfactant and polymer. Preferably, said formulation or composition further comprises one or more of the following: fungicide, nematicide, bactericide, insecticide, molluscicide, algicide, herbicide, fertilizer, micronutrient fertilizer material, stabilizer, preservative, carrier or excipient, complexing agent, or any combination thereof.

In an embodiment, the bacterial population of the formulation or composition are shelf-stable, and said formulation is shelf-stable. Optionally, the shelf-stable formulation is in a dry formulation, a powder formulation, or a lyophilized formulation. In some embodiments, the formulation is formulated to provide stability for the bacteria. In one embodiment, the formulation or composition is substantially stable at temperatures between about −20° C. and about 50° C. for at least about 1, 2, 3, 4, 5, or 6 days, or 1, 2, 3 or 4 weeks, or 1, 2, 3, 4, 5, 6, 7, 8, 9, 10, 11 or 12 months, or one or more years. In another embodiment, the formulation or composition is substantially stable at temperatures between about 4° C. and about 37° C. for at least about 5, 10, 15, 20, 25, 30 or greater than 30 days.

In an embodiment, an agricultural active formulation or composition comprises an agriculturally compatible carrier or agriculturally compatible excipient and one or more purified bacterial strains or microbial active ingredients derived thereof as described before. Said purified bacterial strains or microbial active ingredients derived thereof preferably are present at a concentration of at least about 10² CFU, cells or spores/ml in a liquid formulation; or at least about 10² CFU, cells or spores/mg in a non-liquid formulation. As non-limiting example, said cells may be living cells or spray-dried cells. Such enhanced concentrations of said bacterial strains are not found in nature. The bacterial strains have been propagated until they reached said concentrations. Preferably, the concentration of one or more microbial active ingredients is further effective to improve the plant growth and/or yield.

Bacterial strains produce a plethora of small compounds and secondary metabolites that can be secreted in the culture or be stored endogenously. These may be the microbial active ingredients derived from said bacterial strains. In a particular embodiment, a supernatant from the culture wherein the bacterial strain of current invention has been cultured is utilized. In another embodiment, an extract or extract fraction from the culture wherein the bacterial strain of current invention has been cultured is useful for controlling a pest or pathogen in a plant. Non-limiting examples of endogenous products are amino acids, peptides, enzymes, secondary metabolites, vitamins, minerals. In some embodiments, a metabolite produced by the purified bacterial strain of the present invention is contemplated. In some embodiments, a cell-free or inactivated preparation of the purified bacterial strain of the present invention is contemplated. Removing the cell walls and/or cell membranes of the bacterial strain in culture can be obtained by several procedures which are well-known by the person skilled in the art. Non-limiting examples are the addition of chemicals to said culture, heating said culture or induce lysis in a mechanical way. An extract can also be obtained by autolysis of the bacterial strain. In a preferred embodiment, the microbial active ingredient comprises a spore suspension, spray dried spores, or whole cell broth.

In an embodiment, said formulation or composition comprises a pure bacterial population as active ingredient. In another or further embodiment, said formulation comprises one or more strains as disclosed herein as a mixture. In an embodiment, said formulation comprises at least 2, at least 3 or at least 4 strains as disclosed herein or any suitable mixture. Said combination of strains preferably has a synergistic effect in controlling (a) pest(s) or pathogen(s) in a plant and preferably further in in improving plant growth and/or yield.

Said formulation or composition may be further supplemented with an active ingredient such as a fertilizer, a micronutrient fertilizer material, an insecticide, an herbicide, a plant growth amendment, a fungicide, a molluscicide, an algicide, a bacterial inoculant, a fungal inoculant, or a combination thereof.

In some cases said fertilizer is a liquid fertilizer. Liquid fertilizer can include without limitation, ammonium sulfate, ammonium nitrate, ammonium sulfate nitrate, ammonium chloride, ammonium bisulfate, ammonium polysulfide, ammonium thiosulfate, aqueous ammonia, anhydrous ammonia, ammonium polyphosphate, aluminum sulfate, calcium nitrate, calcium ammonium nitrate, calcium sulfate, calcined magnesite, calcitic limestone, calcium oxide, hampene (chelated iron), dolomitic limestone, hydrate lime, calcium carbonate, diammonium phosphate, monoammonium phosphate, potassium nitrate, potassium bicarbonate, monopotassium phosphate, magnesium nitrate, magnesium sulfate, potassium sulfate, potassium chloride, sodium nitrates, magnesian limestone, magnesia, disodium dihydromolybdate, cobalt chlorid hexahydrate, nickel chloride hexahydrate, indole butyric acid, L-tryptophan, urea, urea-formaldehydes, urea ammonium nitrate, sulfur-coated urea, polymer-coated urea, isobutylidene diurea, K2SO4-2MgSO4, kainite, sylvinite, kieserite, Epsom salts, elemental sulfur, marl, ground oyster shells, fish meal, oil cakes, fish manure, blood meal, rock phosphate, super phosphates, slag, bone meal, wood ash, manure, bat guano, peat moss, compost, green sand, cottonseed meal, feather meal, crab meal, fish emulsion or a combination thereof. The micronutrient fertilizer material can comprise boric acid, a borate, a boron frit, copper sulfate, a copper frit, a copper chelate, a sodium tetraborate decahydrate, an iron sulfate, an iron oxide, iron ammonium sulfate, an iron frit, an iron chelate, a manganese sulfate, a manganese oxide, a manganese chelate, a manganese chloride, a manganese frit, a sodium molybdate, molybdic acid, a zinc sulfate, a zinc oxide, a zinc carbonate, a zinc frit, zinc phosphate, a zinc chelate or a combination thereof. The insecticide can include an organophosphate, a carbamate, a pyrethroid, an acaricide, an alkyl phthalate, boric acid, a borate, a fluoride, sulfur, a haloaromatic substituted urea, a hydrocarbon ester, a biologically-based insecticide, or a combination thereof. The herbicide can comprise a chlorophenoxy compound, a nitrophenolic compound, a nitrocresolic compound, a dipyridyl compound, an acetamide, an aliphatic acide, an anilide, a benzamide, a benzoic acid, a benzoic acid derivative, anisic acid, an anisic acid derivative, a benzonitrile, benzothiadiazinone dioxide, a thiocarbamate, a carmabate, carbanilate, chloropyridinyl, a cyclohexenone derivative, a dinitroaminobenzene derivative, a fluorodinitrotoluidine compound, isoxazolidinone, nicotinic acide, isopropylamine, an isopropulamine derivative, oxadiazolinone, a phosphate, a phthalate, a picolinic acid compound, a triazine, a triazole, a uracil, a urea derivative, endothall, sodium chlorate, or a combination thereof. The fungicide can comprise a substituted benzene, a thiocarbamate, an ethylene bis dithiocarbamate, a thiophthalidamide, a copper compound, an organomercury compound, an organotin compound, a cadmium compound, anilazine, benomyl, cyclohexamide, dodine, etridiazole, iprodione, metlaxyl, thiamimefon, triforine, or a combination thereof.

Said active ingredient may include other microorganisms, such as said bacterial inoculant or fungal inoculant, preferably which are shown to elicit a beneficiary action to a plant, e.g. pest or pathogen control. More preferably said inoculants also show a positive impact on plant growth and/or yield.

Without wishing to be limitative, said formulation may comprise a fungal inoculant of the family Glomeraceae, a fungal inoculant of the family Claroidoglomeraceae, a fungal inoculant of the family Acaulosporaceae, a fungal inoculant of the family Sacculospraceae, a fungal inoculant of the family Entrophosporaceae, a fungal inoculant of the family Pacidsproraceae, a fungal inoculant of the family Diversisporaceae, a fungal inoculant of the family Paraglomeraceae, a fungal inoculant of the family Archaeosporaceae, a fungal inoculant of the family Geosiphonaceae, a fungal inoculant of the family Ambisporacea, a fungal inoculant of the family Scutellosproaceae, a fungal inoculant of the family Dentiscultataceae, a fungal inoculant of the family Racocetraceae, a fungal inoculant of the phylum Basidiomycota, a fungal inoculant of the phylum Ascomycota, a fungal inoculant of the phylum Zygomycota, a fungal inoculant of the genus Glomus or a combination thereof.

Without wishing to be limitative, said formulation may comprise a bacterial inoculant of genus Rhizobium, bacterial inoculant of the genus Bradyrhizobium, bacterial inoculant of the genus Mesorhizobium, bacterial inoculant of the genus Azorhizobium, bacterial inoculant of the genus Allorhizobium, bacterial inoculant of the genus Burkholderia, bacterial inoculant of the genus Sinorhizobium, bacterial inoculant of the genus Kluyvera, bacterial inoculant of the genus Azotobacter, bacterial inoculant of the genus Pseudomonas, bacterial inoculant of the genus Azosprillium, bacterial inoculant of the genus Bacillus, bacterial inoculant of the genus Streptomyces, bacterial inoculant of the genus Paenibacillus, bacterial inoculant of the genus Paracoccus, bacterial inoculant of the genus Enterobacter, bacterial inoculant of the genus Alcaligenes, bacterial inoculant of the genus Mycobacterium, bacterial inoculant of the genus Trichoderma, bacterial inoculant of the genus Gliocladium, bacterial inoculant of the genus Klebsiella, or a combination thereof.

In an embodiment, said formulation or composition may comprise an agriculturally compatible carrier or excipient. Said “agriculturally compatible carrier” or “agriculturally compatible excipient” which can be regarded as a vehicle, is generally inert and it must be acceptable in agriculture. Thus, the phrase “agriculturally compatible” denotes a substance that can be used routinely under field conditions without interfering with growers' planting equipment, and without adversely influencing crop development or the desired ecological balance in a cultivated area.

The agriculturally compatible carrier or excipient can be solid. Solid carriers or excipients can include but are not limited to clays, natural or synthetic silicates, silica, resins, waxes, solid fertilizers, a polymer, a granular mass, perlite, a perlite granule, peat, a peat pellet, soil, vermiculite, charcoal, sugar factory carbonation press mud, rice husk, carboxymethyl cellulose, fine sand, calcium carbonate, flour, alum, a starch, talc, polyvinyl pyrrolidone, or a combination thereof. The agriculturally compatible carrier or excipient can be a liquid. Liquid carriers or excipients can include but are not limited to water, alcohols, ketones, petroleum fractions, oils, aromatic or paraffinic hydrocarbons, chlorinated hydrocarbons, liquefied gases or a combination thereof. More particularly, the agriculturally compatible carrier or excipient can include a dispersant, a surfactant, an additive, a thickener, an anti-caking agent, residue breakdown, a composting formulation, a granular application, diatomaceous earth, a coloring agent, a stabilizer, a preservative, a polymer, a coating or a combination thereof. One of the ordinary skills in the art can readily determine the appropriate carrier or excipient to be used taking into consideration factors such as a particular bacterial strain, plant to which the inoculum is to be applied, type of soil, climate conditions, whether the inoculum is in liquid, solid or powder form, and the like. The additive can comprise an oil, a gum, a resin, a clay, a polyoxyethylene glycol, a terpene, a viscid organic, a fatty acid ester, a sulfated alcohol, an alkyl sulfonate, a petroleum sulfonate, an alcohol sulfate, a sodium alkyl butane diamate, a polyester of sodium thiobutant dioate, a benzene acetonitrile derivative, a proteinaceous material, or a combination thereof. The proteinaceous material can include a milk product, wheat flour, soybean meal, blood, albumin, gelatin, or a combination thereof. The thickener can comprise a long chain alkylsulfonate of polyethylene glycol, polyoxyethylene oleate or a combination thereof. The surfactant can contain a heavy petroleum oil, a heavy petroleum distillate, a polyol fatty acid ester, a polyethoxylated fatty acid ester, an aryl alkyl polyoxyethylene glycol, an alkyl amine acetate, an alkyl aryl sulfonate, a polyhydric alcohol, an alkyl phosphate, or a combination thereof. The anti-caking agent can include a sodium salt such as a sodium sulfite, a sodium sulfate, a sodium salt of monomethyl naphthalene sulfonate, or a combination thereof; or a calcium salt such as calcium carbonate, diatomaceous earth, or a combination thereof. The agriculturally compatible carrier or excipient can also include a fertilizer, a micronutrient fertilizer material, an insecticide, a herbicide, a plant growth amendment, a fungicide, a molluscicide, an algicide, a bacterial inoculant, a fungal inoculant, or a combination thereof. Non-limiting examples are provided above.

In an embodiment, the agricultural active formulation or purified bacterial strain of the present invention can be applied to the soil, plant, seed, rhizosphere, or other areas of the plant to which it would be beneficial to apply the agricultural active formulation comprising the purified bacterial strain, agricultural active formulation or microbial active ingredient derived of said bacterial strain of the invention.

In a third aspect, the present invention relates to the use of a purified bacterial strain as described before or the agricultural formulation as described before, to control a pest or pathogen in plants. In a preferred embodiment, said strain is a strain as deposited under the Budapest Treaty with the Polish Collection of Microorganisms, as Deposit ID: B/00234, B/00233, B/00235 or B/00309; a mutant of a strain deposited under B/00234, B/00233, B/00235 or B/00309, said mutant is still capable of controlling a pest or a pathogen in a plant, or having at least 98%, more preferably at least 98.1%, more preferably at least 98.2%, more preferably at least 98.3%, more preferably at least 98.4%, more preferably at least 98.5%, more preferably at least 98.6%, more preferably at least 98.7%, more preferably at least 98.8%, more preferably at least 98.9%, more preferably at least 99%, more preferably at least 99.1%, more preferably at least 99.2%, more preferably at least 99.3%, more preferably at least 99.4%, more preferably at least 99.5%, more preferably at least 99.6%, more preferably at least 99.7%, more preferably at least 99.8%, more preferably at least 99.9% genomic sequence identity with a bacterial strain as deposited as Deposit ID: B/00234, B/00233, B/00235 or B/00309 and still capable of controlling a pest or pathogen in a plant.

Said mutant of said deposited strains and/or said strain having a specific amount of genomic sequence identity with said deposited bacterial strain, which is still capable of controlling a pest or a pathogen, is preferably capable to control said pest or said pathogen in a manner similar as the deposited strains B/00234, B/00233, B/00235 or B/00309. Preferably, said mutant of said deposited strains and/or said strain having a specific amount of genomic sequence identity with said deposited bacterial strain, still produces albofungin. Preferably said mutant of said deposited strains and/or said strain having a specific amount of genomic sequence identity with said deposited bacterial strain further still produces one or more metabolites selected from the group of streptimidone, N-myristylamidopropyl-N,N-dimethylbetaine, pimaricin, enactin Ia/Ib and lauramidopropyl betaine.

Preferably said pest or pathogen is a pest or pathogen as described below. Preferably, said plant is selected from the list provided below. More preferably said plant is a crop, most preferably said plant is Triticum, Secale, Hordeum or Avena.

In an embodiment, said purified bacterial strain or agricultural formulation as described before is used in post-harvest treatment of various diseases related to pests or pathogen as described below, on various plants as described below.

“Post-harvest” is defined as the stage of plant or crop production immediately following harvest, including cooling, cleaning, sorting and packing. The instant a crop is removed from the ground, or separated from its parent plant, it begins to deteriorate. Postharvest treatment of a crop largely determines final quality, whether a crop is sold for fresh consumption, or used as an ingredient in a processed food product.

In an embodiment said purified bacterial strain or agricultural formulation as described before is used in integrated pest management programs.

“Integrated pest management” (IPM), also known as “integrated pest control” (IPC), is a broad-based approach that integrates practices for economic control of pests. IPM aims to suppress pest populations below the economic injury level (EIL). The UN's Food and Agriculture Organization defines IPM as “the careful consideration of all available pest control techniques and subsequent integration of appropriate measures that discourage the development of pest populations and keep pesticides and other interventions to levels that are economically justified and reduce or minimize risks to human health and the environment. IPM emphasizes the growth of a healthy crop with the least possible disruption to agro-ecosystems and encourages natural pest control mechanisms”.

In a final aspect, the present invention relates to a method of controlling a pest or pathogen in plants. Said method comprises artificially introducing a purified bacterial strain, a bacterial population comprising said bacterial strain, an agriculturally active formulation comprising said bacterial strain or a microbial active ingredient derived from said bacterial strain to a plant, a plant part or a substrate comprising or hosting said plant, thereby conferring pest or pathogen resistance or pest or pathogen control to said plant, wherein said bacterial strain is a purified bacterial strain as described before, and said agricultural active formulation is an agricultural active formulation or composition as described before.

In a preferred embodiment, said strain is a strain as deposited under the Budapest Treaty with the Polish Collection of Microorganisms, as Deposit ID: B/00234, B/00233, B/00235 or B/00309; a mutant of a strain deposited under B/00234, B/00233, B/00235 or B/00309, said mutant is still capable of controlling a pest or a pathogen in a plant, or having at least 98%, more preferably at least 98.1%, more preferably at least 98.2%, more preferably at least 98.3%, more preferably at least 98.4%, more preferably at least 98.5%, more preferably at least 98.6%, more preferably at least 98.7%, more preferably at least 98.8%, more preferably at least 98.9%, more preferably at least 99%, more preferably at least 99.1%, more preferably at least 99.2%, more preferably at least 99.3%, more preferably at least 99.4%, more preferably at least 99.5%, more preferably at least 99.6%, more preferably at least 99.7%, more preferably at least 99.8%, more preferably at least 99.9% genomic sequence identity with a bacterial strain as deposited as Deposit ID: B/00234, B/00233, B/00235 or B/00309 and still capable of controlling a pest or pathogen in a plant.

Said mutant of said deposited strains and/or said strain having a specific amount of genomic sequence identity with said deposited bacterial strain, which is still capable of controlling a pest or a pathogen, is preferably capable to control said pest or said pathogen in a manner similar as the deposited strains B/00234, B/00233, B/00235 or B/00309. Preferably, said mutant of said deposited strains and/or said strain having a specific amount of genomic sequence identity with said deposited bacterial strain, still produces albofungin. Preferably said mutant of said deposited strains and/or said strain having a specific amount of genomic sequence identity with said deposited bacterial strain further still produces one or more metabolites selected from the group of streptimidone, N-myristylamidopropyl-N,N-dimethylbetaine, pimaricin, enactin Ia/Ib and lauramidopropyl betaine.

In an embodiment, said bacterial strain is soil sourced and further propagated outside its original environment.

The current method is particularly useful to be used for monocotyledonous and dicotyledonous plants, including fodder or forage legumes, ornamental plants, food crops, trees or shrubs. Preferably said plant is selected from the list comprising Acer spp., Actinidia spp., Abelmoschus spp., Agave sisalana, Agropyron spp., Agrostis stolonifera, Allium spp., Amaranthus spp., Ammophila arenaria, Ananas comosus, Annona spp., Apium graveolens, Arachis spp., Artocarpus spp., Asparagus officinalis, Avena spp. (e.g. Avena sativa, Avena fatua, Avena byzantina, Avena fatua var. sativa, Avena hybrida), Averrhoa carambola, Bambusa sp., Benincasa hispida, Bertholletia excelsea, Beta vulgaris, Brassica spp. (e.g. Brassica napus, Brassica rapa ssp. [canola, oilseed rape, turnip rape]), Cadaba farinosa, Camellia sinensis, Canna indica, Cannabis sativa, Capsicum spp., Carex elata, Carica papaya, Carissa macrocarpa, Carya spp., Carthamus tinctorius, Castanea spp., Ceiba pentandra, Cichorium endivia, Cinnamomum spp., Citrullus lanatus, Citrus spp., Cocos spp., Coffea spp., Colocasia esculenta, Cola spp., Corchorus sp., Coriandrum sativum, Corylus spp., Crataegus spp., Crocus sativus, Cucurbita spp., Cucumis spp., Cynara spp., Daucus carota, Desmodium spp., Dimocarpus longan, Dioscorea spp., Diospyros spp., Echinochloa spp., Elaeis sp. (e.g. Elaeis guineensis, Elaeis oleifera), Eleusine coracana, Eragrostis tef, Erianthus sp., Eriobotrya japonica, Eucalyptus sp., Eugenia uniflora, Fagopyrum spp., Fagus spp., Festuca arundinacea, Ficus carica, Fortunella spp., Fragaria spp., Ginkgo biloba, Glycine spp. (e.g. Glycine max, Soja hispida or Soja max), Gossypium hirsutum, Helianthus spp. (e.g. Helianthus annuus), Hemerocallis fulva, Hibiscus spp., Hordeum spp. (e.g. Hordeum vulgare), Ipomoea batatas, Juglans spp., Lactuca sativa, Lathyrus spp., Lens culinaris, Linum usitatissimum, Litchi chinensis, Lotus spp., Luffa acutangula, Lupinus spp., Luzula sylvatica, Lycopersicon spp. (e.g. Lycopersicon esculentum, Lycopersicon lycopersicum, Lycopersicon pyriforme), Macrotyloma spp., Malus spp., Malpighia emarginata, Mammea americana, Mangifera indica, Manihot spp., Manilkara zapota, Medicago sativa, Melilotus spp., Mentha spp., Miscanthus sinensis, Momordica spp., Morus nigra, Musa spp., Nicotiana spp., Olea spp., Opuntia spp., Ornithopus spp., Oryza spp. (e.g. Oryza sativa, Oryza latifolia), Panicum miliaceum, Panicum virgatum, Passiflora edulis, Pastinaca sativa, Pennisetum sp., Persea spp., Petroselinum crispum, Phalaris arundinacea, Phaseolus spp., Phleum pratense, Phoenix spp., Phragmites australis, Physalis spp., Pinus spp., Pistacia vera, Pisum spp., Poa spp., Populus spp., Prosopis spp., Prunus spp., Psidium spp., Punica granatum, Pyrus communis, Quercus spp., Raphanus sativus, Rheum rhabarbarum, Ribes spp., Ricinus communis, Rubus spp., Saccharum spp., Salix sp., Sambucus spp., Secale cereale, Sesamum spp., Sinapis sp., Solanum spp. (e.g. Solanum tuberosum, Solanum integrifolium or Solanum lycopersicum), Sorghum bicolor, Spinacia spp., Syzygium spp., Tagetes spp., Tamarindus indica, Theobroma cacao, Trifolium spp., Tripsacum dactyloides, Triticosecale rimpaui, Triticum spp. (e.g. Triticum aestivum, Triticum durum, Triticum turgidum, Triticum hybernum, Triticum macha, Triticum sativum, Triticum monococcum or Triticum vulgare), Tropaeolum minus, Tropaeolum majus, Vaccinium spp., Vicia spp., Vigna spp., Viola odorata, Vitis spp., Zea mays, Zizania palustris, Ziziphus spp., amongst others; including the progenies and hybrids between the above.

In a preferred embodiment, said plant is chosen from the group of Avena, Axonopus, Buchloe, Coix, Cynodon, Dactylis, Eragrostis, Eremochloa, Festuca, Hordeum, Lolium, Oryza, Paspalum, Pennisetum, Phleum, Poa, Saccharum, Secale, Sorghum, Stenotaphrum, Triticum, Triticosecala, Zea, and Zoysia, including the progenies and hybrids between the above.

In a particular preferred embodiment, said plant is Triticum, Secale, Hordeum or Avena.

In an embodiment, the current method is particularly useful to control a pest or pathogen in plants as described above. Said pests or pathogen may be any Eukaryotic or Prokaryotic pests, such as but not limited to viral, bacterial, fungal pathogens or insect pests. In an embodiment said pathogens are viral, bacterial or fungal pathogens. In a preferred embodiment, said pests or pathogens are selected from Phytophthora infestans; from viral pathogens such as Barley yellow dwarf virus; form bacterial pathogens such as Xanthomonas sp. (campestris), Pseudomonas syringae, Rhizobium sp.; from fungal pathogens such as Tilletia tritici, Claviceps purpurea, Oculimacula spp., Fusarium sp., Phytium sp., Erysiphe graminis, Puccinia graminis, Puccinia triticina, Puccinia striiformis, Pyrenophora tritici-repentis, Ramularia sp. (collo-cygni), Sclerotinia sclerotiorum, Botrytis cinerea, Colletotrichum graminicola, Microdochium nivale, Gaeumannomyces graminis var. tritici, Rhizoctonia solani, Tapesia sp., Thysanoptera, Ustilago spp., Mycosphaerella spp. (i.e. Zymoseptoria tritici); from insect pests such as Rhopalosuphum padi, Diuraphis noxia, Sitobion avenae, Mythimna unipunctata, Spodoptera praefica, Euschistus spp., Aeolus spp., Anchastus spp., Melanotus spp., Limonius spp., Lepidoptera, Orthoptera, Coleoptera or Hemiptera.

Methods for introducing bacteria to plants may include: treating the plant and/or a plant part and/or growth medium wherein said plant is grown, with the bacteria or formulation are described herein; an inoculation method comprising adhering bacteria to seeds; a method comprising coating seeds with bacteria; a method comprising directly inoculating bacteria to plants or plant parts; a method of treating (e.g. spraying) plant ears with the bacteria, or formulation described herein. Preferably, a wheat ear, spike, spikelet, stem and/or leaf is treated.

An appropriate method may be chosen depending on the type of plant to which the bacteria are to be introduced.

For the purpose of introducing said bacterial strain to said plant or plant parts, the bacterial strain may be formulated as an agricultural active formulation comprising said bacterial strain, or a microbial active ingredient derived from said bacterial strain as active ingredient, said formulation is suitable to be used as a pest or pathogen control agent for plants, said bacterial strain or microbial active ingredient are according to one of the embodiments as described above.

As a non-limiting example, the isolated bacterial strain or formulation may be dispersed in physiological saline. This solution may be used to coat seeds with the bacterial strain by spraying on the seeds or soaking said seeds in said solution. In another example, for coating seeds with a solution as described in the previous example, a binding agent may be added, such as a binding agent comprising carbide (calcium carbonate). Alternatively, the bacterial strain or a formulation comprising said bacterial strain may be added to a plant or plant parts, e.g. by inoculation, spraying or wetting of said plant or plant parts.

As another of further non-limiting example, the bacterial strain or microbial active ingredient derived thereof may be applied in the form of coatings or other application. In embodiments, the coating may be applied to a naked and untreated plant part. In other embodiments, the coating may be applied as an overcoat to a previously treated plant part. Preferably, the microorganisms are applied in the form of seed coatings or other applications to the seed. Seed coatings are particularly preferred in the treatment of soil borne fungal diseases. In embodiments, the seed coating may be applied to a naked and untreated seed. In other embodiments, the seed coating may be applied as a seed overcoat to a previously treated seed. Applying said bacterial strains or microbial consortia to plant parts, like a seed, the plant itself or its substrate modulates a trait of agronomic importance. The trait of agronomic importance can be amongst others pathogen or pest resistance, plant growth, and/or plant yield.

In an embodiment, the bacterial strain or microbial active ingredient derived thereof may be applied to the soil or any other substrate in which said plant grows in order to remove pests and/or pathogen from said substrate.

Inoculating the substrate comprising or hosting said plant or plant part can be performed, by way of example and without the intention to be limiting, using a powder, a granule, a pellet, a plug, or a soil drench that is applied to the substrate. Inoculation could also be performed by a liquid application, such as a foliar spray or liquid composition. The application may be applied to a growing plant or to the substrate. Plants, in particular agricultural plants, can be grown in substrate. In one embodiment, said substrate is soil, sand, gravel, polysaccharide, mulch, compost, peat moss, straw, logs, clay, or a combination thereof. In another embodiment, the substrate can also include a hydroculture system or an in vitro culture system. In some embodiments, a combination of different application methods as described herein is applied. In a non-limiting example, wheat plants are treated against Fusarium spp. and Puccinia spp. by foliar application. Also strawberry plants and tomato plants may for example be treated against Botrytis spp. by foliar application. In another non-limiting example, lettuce plants are treated against Rhizoctonia spp. and Pythium spp. by foliar application, subsequently followed by soil drench applications.

The invention is further described by the following non-limiting examples which further illustrate the invention, and are not intended to, nor should they be interpreted to, limit the scope of the invention.

### EXAMPLES

The present invention will now be further exemplified with reference to the following examples. The present invention is in no way limited to the given examples or to the embodiments presented in the figures.

### Example 1: In Vitro Inhibition of Fungal Plant Pathogens of Various Genera

Purified bacterial strains according to the present invention B/00234, B/00233, B/00235 and B/00309 were used in a co-culturing experiment with fungal (plant) pathogen strains of various genera (Table 1). Solid medium, either Nutrient Agar (NA), 1/10 Nutrient Agar or Potato Dextrose Agar (PDA) was prepared and dispensed over petri dishes with a diameter of 8 cm. The purified bacterial strains were cultured in liquid Nutrient Broth until a dense bacterial culture was obtained. 10 μl of the liquid culture was taken and inoculated at 2.5 cm from the center of the petri dish and subsequently incubated at 28° C. overnight. Subsequently, the center of the petri dish was inoculated with 15 μl of a liquid culture of the fungal pathogen and incubated at 21° C. for at least three days.

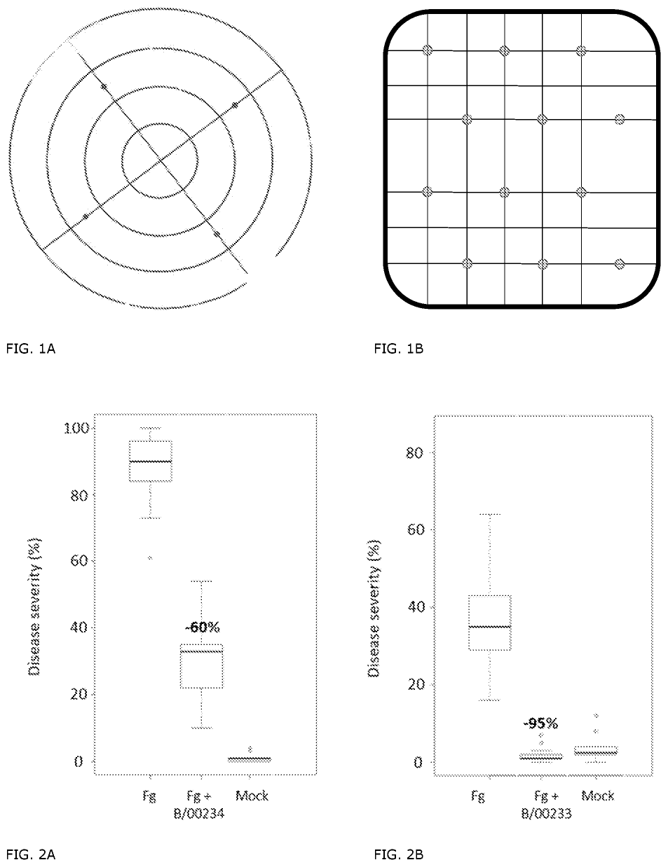

The inhibiting potential or antifungal activity of the bacterial strains according to the present invention on said fungal pathogens was tested and scored based on the growth inhibition zone or fungal growth radius, measured as from the center of the petri dish. Reference is made to the template shown in FIG. 1A. Score A indicates that the fungus only grows in the inner circle of the template (fungal radius <10 mm). Score B means that the fungus also grows in the second circle counted from the center, but does not grown further than the bacterial strain (fungal radius=10-20 mm). Score C is given when there is an inhibition zone/halo around the bacterial strain, but the fungus can grow past the bacterial strain. Score D means that the fungus can grow up to the bacterial strain, but does not grow over it. A small inhibition zone is visible past the bacterial strain. Finally, score E is given when there is no inhibition of the fungus, and the fungus grows over the bacterial strain. Bacterial strain/fungus combinations which were not tested are indicated with “/”.

Table 1: inhibition scores for four bacterial strains against different pathogenic fungi, and the medium on which the experiment was performed. Reference is made to the template shown in FIG. 1A. Score A: The fungus only grows in the inner circle of the template. Fungal radius is <10 mm. Score B: The fungus also grows in the second circle but not behind the bacterial strain. Fungal radius=10-20 mm. Score C: There is an inhibition zone/halo around the bacterial strain, but the fungus can grow behind the bacterial strain. Score D: The fungus can grow up to the bacterial strain but does not grow over it. Behind the bacterial strain there is a small inhibition zone. Score E: No inhibition of the fungus, the fungus grows over the bacterial strain. 11 indicates that the combination was not tested.

| | | Deposit ID | | | |
|---|---|---|---|---|---|
| Fungus (pathogen) | Medium | B/00234 | B/00233 | B/00235 | B/00309 |
| Fusarium graminearum | 1/10 NA | A | A | A | B |
| Zymoseptoria tritici | NA | A | A | A | / |
| Ramularia collo-cygni | 1/10 NA | A | A | A | / |
| Sclerotinia sclerotiorum | 1/10 NA | A | A | A | / |
| Fusarium oxysporum | 1/10 NA | A | A | A | / |
| strain MUCL 39793 | | | | | |
| Fusarium oxysporum | PDA | / | A | A | / |
| strain MUCL 39793 | | | | | |
| Fusarium oxysporum | 1/10 NA | B | B | B | / |
| strain 2.46 | | | | | |
| Fusarium pseudograminearum | 1/10 NA | A | A | A | / |
| Rhizoctonia solani | 1/10 NA | A | A | A | / |
| Botrytis cinerea | 1/10 NA | A | A | A | / |
| Colletotrichum graminicola | 1/10 NA | A | A | A | / |
| Microdochium nivale | 1/10 NA | A | A | A | / |
| Gaeumannomyces graminis | 1/10 NA | A | A | A | / |
| var. tritici | | | | | |
| Tapesia yallundae | PDA | A | A | A | / |
| Phytophthora infestans | PDA | A | A | A | / |

Results of the inhibition test indicate a strong inhibitory effect (scores A and B) of the purified bacterial strains B/00234, 1B/00233 and 1B/00235 on all listed fungal plant pathogens. In addition, purified bacterial strain 1B/00309 showed a strong inhibitory effect on Fusarium graminearum, but was however not yet tested against the other fungi.

### Example 2: In Vitro Inhibition of a Bacterial Plant Pathogen of the Genus Rhizobium

Purified bacterial strains according to the present invention B/00233, B/00234 and B/00235 were co-cultured with a pathogenic bacterial strain of the species Rhizobium rhizogenes, grown in NB at 28° C. Solid medium NA with 1% of the bacterial strain was prepared as following. 0.5 mL of the pure Rhizobium rhizogenes solution in NB was diluted in 4.5 mL sterile MilliQ water. This 5 mL 1/10 diluted Rhizobium rhizogenes solution was added to 45 mL liquid NA. Finally, the Rhizobium rhizogenes/NA solution was used to pour a 12 cm square plate. After the plate was dried, 2.5 μL of the bacterial strain was spotted on the plate according to a template. The inhibiting potential or antibacterial activity of the bacterial strains according to the present invention on said Rhizobium rhizogenes was tested and scored based on the growth inhibition zone around the bacterial strain (r). Reference is made to the template shown in FIG. 1B. Score A indicates a growth inhibition zone around the bacterial strain of more than 15 mm (r>15 mm). Score B means that the growth inhibition zone around the bacterial strain was between 10 and 15 mm (15 mm>r>10 mm). Score C was given when r was 2 and 10 mm (10 mm>r>2 mm). Score D means that r was below 2 mm (r<2 mm). Score E indicated that there is no inhibition of the pathogenic bacterial strain, and the pathogen grew over the bacterial strain. Finally, score F was given when the bacterial strain was not able to grow due to the presence of the pathogenic bacterial strain.

Results of the inhibition tests were given a score C for all three isolated bacterial strains on the plant bacterium Rhizobium rhizogenes, indicating an inhibitory effect on the growth of said pathogenic bacterium.

### Example 3: In Planta Inhibition of Fungal Pathogen Fusarium graminearum

Fusarium graminearum (Fg), also referred to as Gibberella zeae, is a fungal plant pathogen causing fusarium head blight on wheat and barley. Bacterial strains B/00234, B/00233, B/00309 and B/00235 were used for in planta inhibition experiments of the fungus on wheat (Triticum aestivum). For the bacterial treatments, wheat plants were treated preventive with the bacterial strain. Two days later the plants were treated with spores of Fusarium. As a mock treatment, wheat plants were treated preventive with the bacterial formulation only, without bacterial strain. As a positive control, wheat plants were treated only with Fusarium. Disease severity (%) was measured after 2 to 3 weeks in a growth chamber using Fusarium Vision, an in-house developed algorithm linked to an imaging technology for Fusarium disease scoring on wheat spikes. Results are shown in FIGS. 2A-2D.

Wheat ears treated with B/00234 showed a decrease of disease severity of 60%, B/00233 showed a decrease of 95%, for B/00309 a decrease of 74% was shown, and for B/00235 this was a decrease of 97% compared to a situation where the plant was only treated with pathogenic fungus, and not with one of the bacterial strains.

### Example 4: In Planta Inhibition of Fungal Pathogen Puccinia striiformis var. tritici

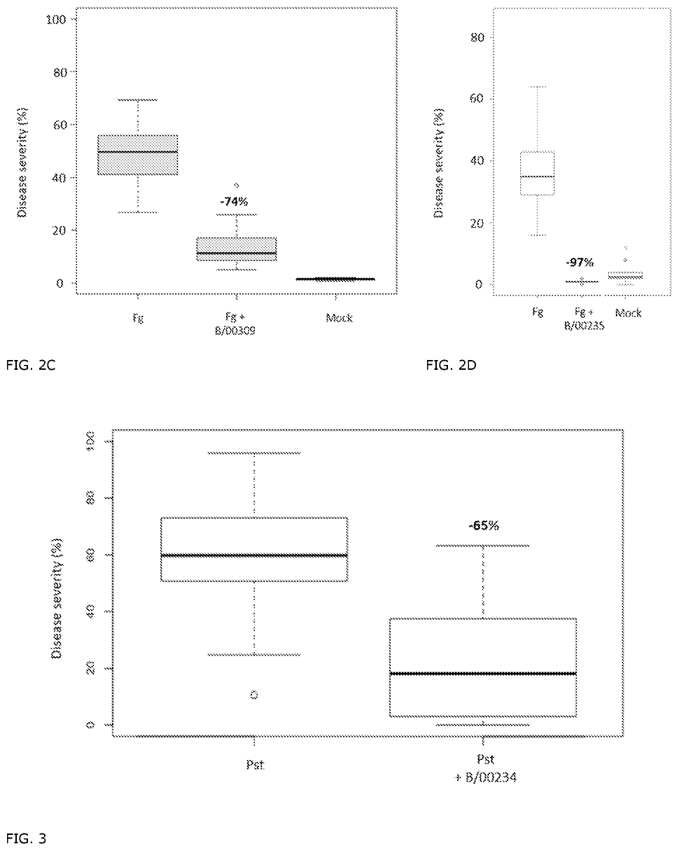

Puccinia striiformis var. tritici is a plant pathogen causing stripe rust on wheat. In analogy to Example 3, bacterial strain B/00234 was used for in planta inhibition experiments of the fungus Puccinia striiformis var. tritici on wheat leaves. Single leaves were treated with the bacterial strain as a preventive treatment and after a short drying period, the plants were treated with Puccinia striiformis var. tritici spores. As positive control, single leaves were sprayed preventive with the bacterial formulation only without bacterial strain, and after a short drying period, the plants were treated with the Puccinia spores. Disease severity (%) was measured after 2 to 3 weeks days in a growth chamber using Puccinia Vision, an in-house developed algorithm linked to an imaging technology for Puccinia disease scoring on wheat leaves. Results are shown in FIG. 3.

Results showed a decrease in disease severity of 65% upon treatment with B/00234, compared to a situation where the plant was only treated with the pathogenic fungus.

### Example 5: In Planta Inhibition of Fungal Pathogen Zymoseptoria triticia

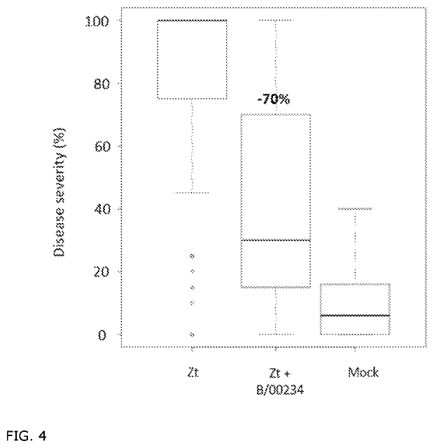

Zymoseptoria triticia, also referred to as Mycosphaerella graminicola or Septoria tritici, is a fungal wheat plant pathogen causing septoria leaf blotch. In analogy to Example 3 and 4, bacterial strains B/00234 was used for in planta inhibition experiments of the fungus Zymoseptoria triticia on wheat leaves. For the bacterial treatment, wheat leaves were treated preventive with the bacterial strain. Two days later the leaves were treated with Zymoseptoria triticia spores. As a mock treatment, wheat leaves were treated preventive with the bacterial formulation only, without bacterial strain. As a positive control, wheat leaves were treated with Zymoseptoria tritici spores only. Disease severity (%) was measured after 2 to 3 weeks in a growth chamber using visual assessment. Results are shown in FIG. 4.

Results showed a decrease in disease severity of 70% upon treatment with B/00234 compared to a situation where the plant was only treated with the pathogenic fungus.

### Example 6: Identification of Metabolite Gene Clusters in the Strains

DNA of the bacterial strains B/00234, B/00233, B/00309 and B/00235 was extracted and sequenced using the whole genome sequencing method Illumina. In order to trace back the antimicrobial and antifungal activity of the bacterial strains, genes involved in the production of secondary metabolites were identified. A tool most commonly used for the identification of metabolite gene clusters is AntiSMASH (https://antismash.secondarymetabolites.org/). The program relies on specific amino acid signatures that are known to be associated with enzymes and regulatory genes in the production of secondary metabolites. From this data it is possible to derive which known compounds or close relatives are encoded within the strains' genome. This data was used to identify compounds related to antimicrobial, antifungal, antiviral and anti-insect activity.

The compounds identified for the bacterial strains B/00234, B/00233, B/00309 and B/00235 were, amongst others, Albonoursin, Methylstreptimidone, Puromycin, Thiazostatin, Xantholipin, Phosphonate, Nystatin, Paenibactin, Paromomycin, Cyclothiazomycin and Mannopeptimycin.

Amino acid sequences relating to these compounds which were identical for all four strains were retained and genes relating to these compounds present in all four strains were identified. Nucleotide sequences were determined. Comparing the corresponding nucleotide sequences for each of said four bacterial strains, revealed similarity of at least 99.6%. Based thereon, sequences with SEQ ID NO: 3-19 were identified.

This analysis resulted in sequences with a sequence similar to SEQ ID NO: 3-19, relating to genes or partial genes known to be associated with gene clusters encoding for enzymes and regulatory genes that are linked to the production of specific classes of secondary metabolites.

### Example 7: Anti-Pathogen Activity of Bacterial Extracts and Identification of Compounds Linked to Said Activity

### 1. Culturing of Bacterial Strains

Four 500 ml Erlenmeyers comprising 125 ml of bacterial growth medium were inoculated each with one of the purified bacterial strains B/00233, B/00234, B/00235 or B/00309 and subsequently incubated in an orbital shaker for 2-5 days at 28° C., 70% humidity, 220 rpm.

### 2. HPLC Fractionation

The mycelium and fermentation broth in flasks were extracted by adding acetone. After filtration, the acetone extract was concentrated under reduced pressure. The aqueous residue was loaded onto a resin column for a solid-phase extraction (SPE) and eluted with acetone. The extract was evaporated and the residue solved in 100% DMSO and filtered at 0.2 mM prior to semi-preparative fractionation to constitute a HPLC head. An aliquot of the flow-though was kept for its possible evaluation of activity if not retained by the SPE resin.

100 mg per extract were then subjected to semi-preparative reversed phase HPLC (Zorbax SB-C8 column, 21.2×250 mm, 7 μm, 20 mL/min, UV detection at 210 and 280 nm) eluting with CH₃CN:H₂O, in a linear gradient of acetonitrile specific for each sample, and a wash step to yield a collection of 80 fractions that were tested for activity against pathogenic strains after evaporation of the organic solvent and preparation of an aliquot per fraction at 100 mg/mL in 20% of DMSO in water.

3. Screening Bacterial Extracts and Fractions Against the Wheat Pathogens Zymoseptoria tritici, Fusarium graminearum and Puccinia striiformis.

To assess the antifungal activity of the bacterial extracts and fractions, three fungal phytopathogenic strains were used, of which two were acquired from two public collections: CBS-KNAW culture collection, Utrecht (Netherlands) and CIRM-CF, French National Institute for Agricultural Research, Marseille (France).

3.1 Fusarium graminearum Agar-Based Screening Assay

Medium used for agar antifungal evaluation was SDA (sabouroad dextrose agar Difco™ 65 g and 1000 mL H2O miliQ). Fusarium spores inoculated media was dispensed in assay plates. Subsequently, the 80 fractions were dispensed to evaluate on the agar surface. Plates were incubated for growth and inhibition halos were measured by the diameter and opacity to assess antimicrobial activity. An extract or fraction is considered as active when its halo diameter is superior to 5 mm.

3.2 Zymoseptoria tritici and Puccinia striiformis Liquid-Based Screening Assays

High throughput screening (HTS) liquid-based assays were performed in 96-well plates. Each well contained 10 μL of extract fraction and 90 μL of specific medium containing conidia of Z. tritici or water agar containing 10 mg/mL of P. striiformis spores.

After specific incubation time for each fungal strain, the extract's antifungal activity was quantified by measuring the absorbance differences at 600 nm between the final and the initial incubation times after the addition of resazurin, an oxidation-reduction indicator of the cell viability. All assays were performed per duplicate. The color of the wells after resazurin addition was also recorded using a Canon camera. A blue color is interpreted as absence of metabolic activity (low ratio of conidia germination). A fluorescent pink color is interpreted as presence of metabolic activity (high ratio of conidia germination). A purple color in the well is interpreted as a trailing result, where some metabolic activity was present, but maybe a longer incubation time would allow the purple color to change to pink. An extract or fraction is considered as active when its percentage of inhibition are superior to 50%.

### 4. LC/HRMS De-Replication of Compounds

Active fractions were subsequently analyzed via Liquid Chromatography-High Resolution Mass Spectrometry (LC-HRMS) using an HPLC machine (detection at 210 nm) interfaced to a mass spectrometer. A Zorbax was used for the separation. Two solvents were used as mobile phase: solvent A water:AcN 90:10, solvent B water:AcN 10:90, both with 13 mM ammonium formate and 0.01% TFA.

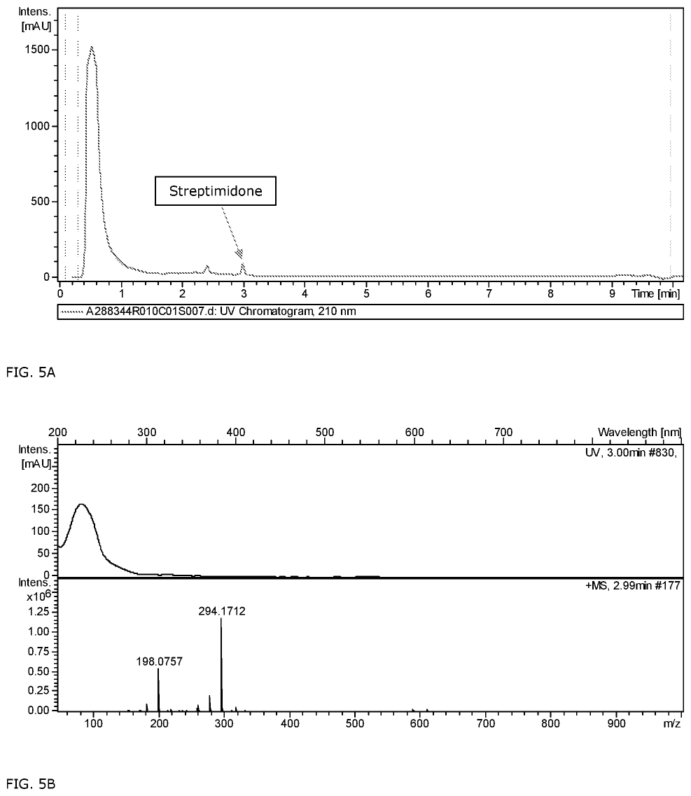

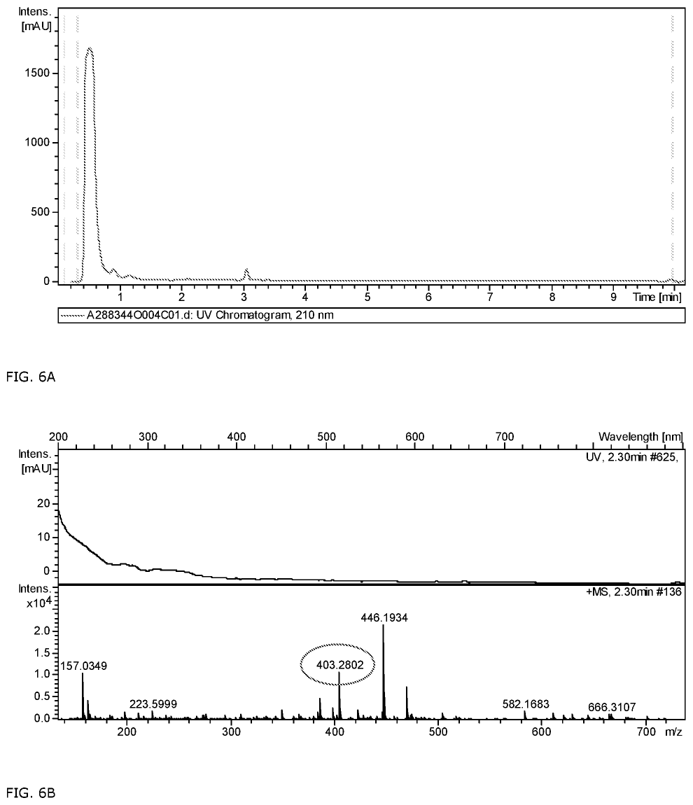

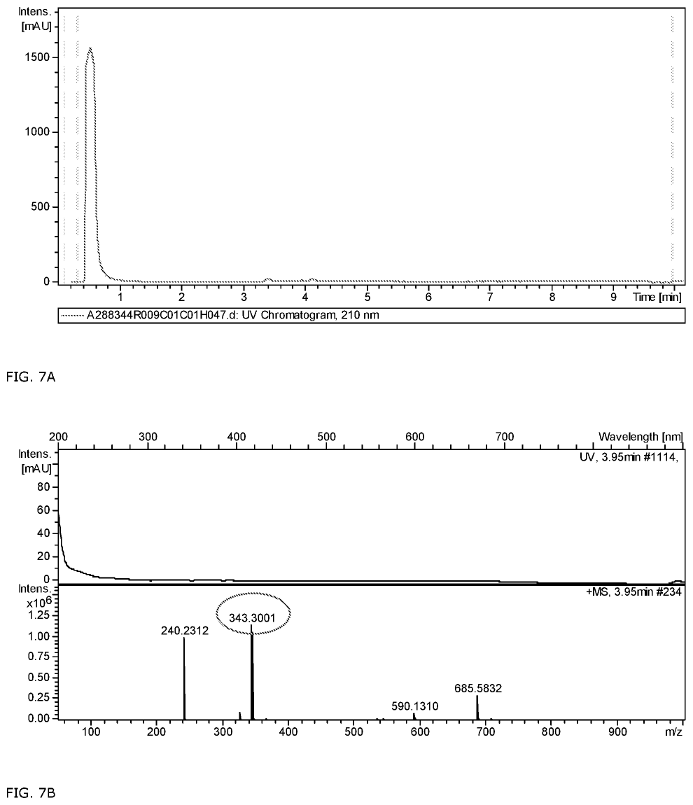

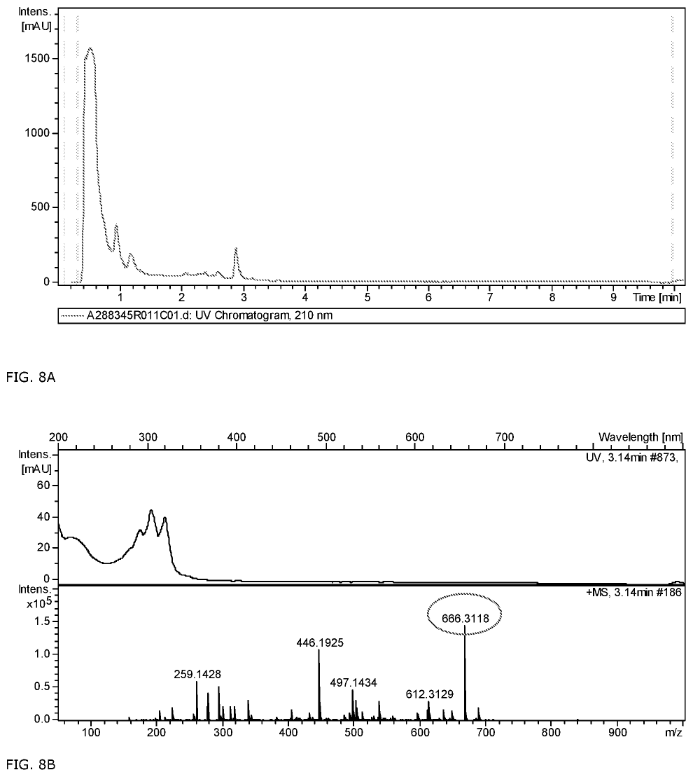

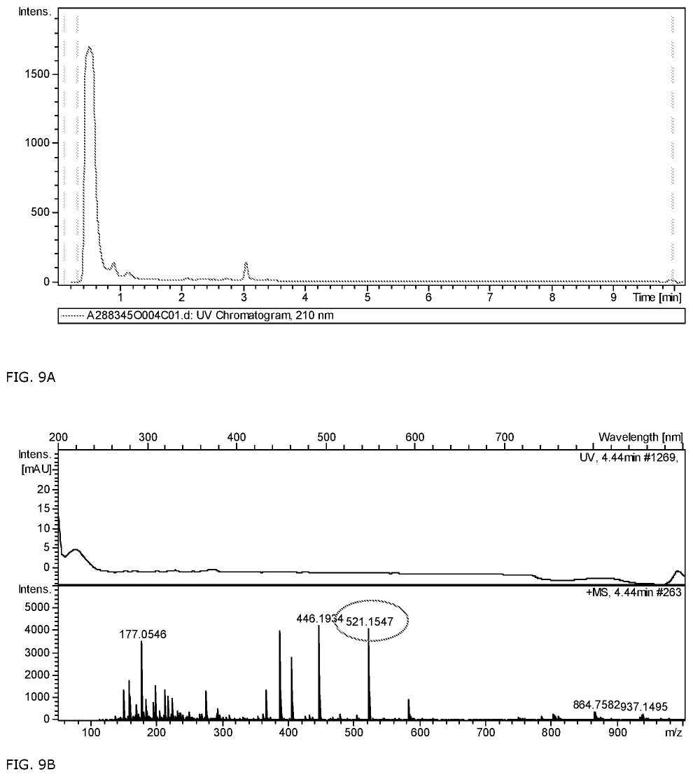

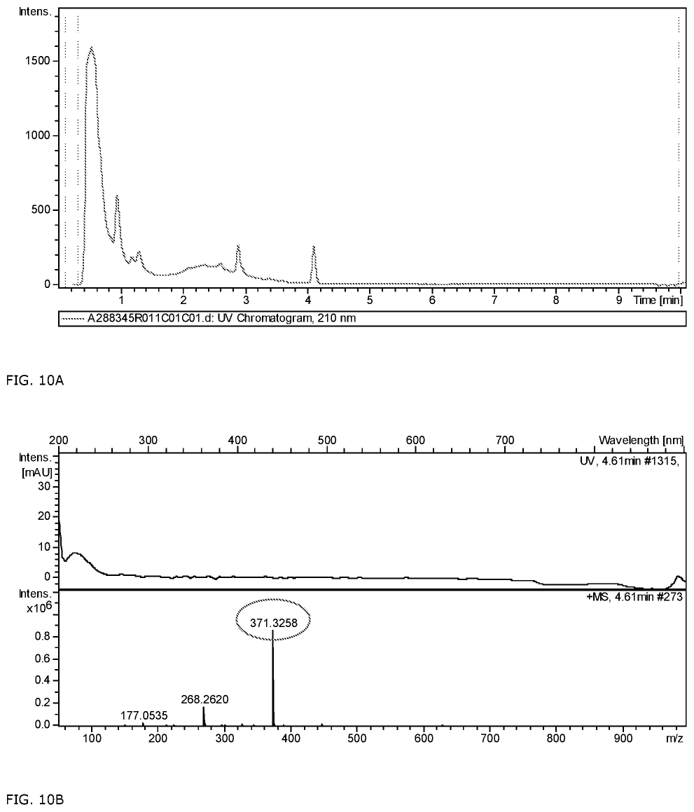

The retention time and exact mass of the detected components were compared against high resolution mass spectrometry databases. Based thereon, the compounds showing activity have been identified as streptimidone (FIGS. 5A and 5B), enactin Ia/Ib (FIGS. 6A and 6B), lauramidopropyl betaine (FIGS. 7A and 7B), pimaricin/natamycin (FIGS. 8A and 8B), albofungin (FIGS. 9A and 9B) and N-Myristylamidopropyl-N,N-dimethylbetaine (FIGS. 10A and 10B) as shown in Table 2 below.

Compounds which have not been detected, may still be produced and secreted by the bacterial strain, however in an amount which was below the detection limits of the screening assays. In addition, it is possible that the compound is encoded in the genome of the strains, but was not expressed at the moment or in the conditions of the screening assays.

Without wishing to be bound to theory, the anti-pathogen and anti-pest activity of the purified bacterial strains according to the present invention, in particular B/00234, B/00233, B/00235 and B/00309, may therefore be (partly) linked to the compounds of Table 2.

TABLE 2
Activity of compounds found in extracts of bacterial strains B/00233,
B/00234, B/00235 and B/00309 against Fusarium graminearum, Zymoseptoria
tritici and Puccinia striiformis.

| Compound/formula | B/00234 | B/00233 | B/00309 | B/00235 | Active against: |
|---|---|---|---|---|---|
| Streptimidone/ | Yes | Yes | Yes | Yes | F. graminearum |
| C16H23NO4 | | | | | Z. tritici |
| | | | | | P. striiformis |
| Pimaricin/Natamycin/ | Yes | Yes | Yes | Yes | F. graminearum |
| C33H47NO13 | | | | | Z. tritici |
| | | | | | P. striiformis |
| Albofungin/C27H24N2O9 | Yes | Yes | Yes | Yes | F. graminearum |
| | | | | | Z. tritici |
| | | | | | P. striiformis |
| N-Myristylamidopropyl- | Yes | Yes | Yes | Yes | F. graminearum |
| N,N-dimethylbetaine | | | | | Z. tritici |
| | | | | | P. striiformis |
| Enactin Ia/Ib | Yes | Yes | Not | Not | F. graminearum |
| | | | detected | detected | Z. tritici |
| | | | | | P. striiformis |
| Lauramidopropyl | Yes | Yes | Yes | Yes | F. graminearum |
| betaine/C19H40N2O4 | | | | | Z. tritici |
| | | | | | P. striiformis |

‘Not detected’: compound not detected by the screening assays

### Example 8: Linking Metabolite Gene Clusters in the Strains to Active Compounds

In a subsequent step, the metabolite gene clusters as identified in Example 6 were aligned with the active compounds found in extracts of bacterial strains B/00234, B/00233, B/00235 and B/00309 from Example 7.

This led to the discovery of a series of 59 consecutive genes found in all four bacterial strains matching 59 consecutive genes in the AntiSMASH albofungin reference gene cluster, having a 100% alignment coverage. This shows that genes required to synthesize the structure of albofungin are present in the four bacterial strains.

Four of these 59 genes match with SEQ ID NO: 9 to 12, also identified as gene sequences associated with the production of xantholipin. In particular, said genes code for (parts of) a polyketide synthase, a monooxygenase, a polyketide synthase and an acyl carrier protein.

Both xantholipin and albofungin are polycyclic xanthone antibiotics that exhibit potent cytotoxic and antibacterial activity.

The present example thus links the sequences with SEQ ID NO: 9 to 12 to the antimicrobial compound albofungin, which has been shown to be produced by four purified bacterial strains according to the present invention B/00234, B/00233, B/00235 and B/00309, and which has been shown to have activity against various plant pathogen and plant pests.

It is understood that screening for these sequences in strains, together with metabolite screening allows for the identification of additional strains conform the current invention.

The present invention is in no way limited to the embodiments described in the examples and/or shown in the figures. On the contrary, methods according to the present invention may be realized in many different ways without departing from the scope of the invention.

1.-19. (canceled)

20. A method for controlling a pest or a pathogen in a plant comprising artificially introducing a purified bacterial strain, a bacterial population comprising said bacterial strain, an agriculturally active formulation comprising said bacterial strain, or a microbial active ingredient derived from said bacterial strain to a plant, a plant part or a substrate comprising or hosting said plant, thereby conferring pest or pathogen resistance or pest or pathogen control to said plant, wherein said bacterial strain:
comprises at least one 16S nucleotide sequence that is at least 99% identical to SEQ ID NO: 1, wherein said strain comprises in its genomic DNA at least one sequence that is at least 95% identical to a sequence chosen from SEQ ID NO: 3 to 12.

21. The method of claim 20, wherein said bacterial strain comprises at least one 16S nucleotide sequence that is at least 99.7% identical to SEQ ID NO:1.

22. The method of claim 20, wherein said bacterial strain produces albofungin.

23. The method of claim 22, wherein said bacterial strain further produces one or more metabolites selected from streptimidone, N-myristylamidopropyl-N,N-dimethylbetaine, pimaricin, enactin Ia/Ib, and/or lauramidopropyl betaine.

24. A method for controlling a pest or a pathogen in a plant comprising artificially introducing a purified bacterial strain, a bacterial population comprising said bacterial strain, an agriculturally active formulation comprising said bacterial strain, or a microbial active ingredient derived from said bacterial strain to a plant, a plant part or a substrate comprising or hosting said plant, thereby conferring pest or pathogen resistance or pest or pathogen control to said plant, wherein said bacterial strain comprises at least one 16S nucleotide sequence that is at least 99% identical to SEQ ID NO:1, and wherein said bacterial strain produces albofungin.

25. The method of claim 24, wherein said bacterial strain further produces one or more metabolites selected from streptimidone, N-myristylamidopropyl-N,N-dimethylbetaine, pimaricin, enactin Ia/Ib and/or lauramidopropyl betaine.

26. The method of claim 24, wherein said bacterial strain comprises in its genomic DNA at least one sequence that is at least 95% identical to a sequence chosen from SEQ ID NO: 3 to 12.

27. The method of claim 20, wherein said bacterial strain comprises in its genomic DNA at least two sequences that are at least 95% identical to a sequence chosen from SEQ ID NO: 3 to 12.

28. The method of claim 20, wherein said bacterial strain produces albofungin and said bacterial strain comprises in its genomic DNA gene sequences having a sequence according to SEQ ID NO: 9 to 12.

29. The method of claim 20, wherein said 16S nucleotide sequence is a sequence according to SEQ ID NO: 1 or SEQ ID NO: 2.

30. The method of claim 20, wherein said bacterial strain comprises in its genomic DNA gene sequences having a sequence according to SEQ ID NO: 3 to 12.

31. The method of claim 20, wherein said bacterial strain comprises in its genomic DNA at least one sequence that is at least 95% identical to a sequence chosen from SEQ ID NO: 15 to 19.

32. The method of claim 20, wherein said bacterial strain comprises in its genomic DNA at least two sequences chosen from SEQ ID NO: 15 to 19.

33. The method of claim 20, wherein said bacterial strain comprises in its genomic DNA at least one sequence that is at least 95% identical to a sequence chosen from SEQ ID NO: 13 to 14.

34. The method of claim 20, wherein a reference of said bacterial strain is deposited with the Polish Collection of Microorganisms, respectively as Deposit ID: B/00234, B/00233, B/00235 or B/00309; is a strain that is a mutant of a strain deposited under B/00234, B/00233, B/00235 or B/00309, said mutant is still capable of controlling a pest or a pathogen in a plant; or is a strain with at least 98% genomic sequence identity with the bacterial strain as deposited as Deposit ID: B/00234, B/00233, B/00235 or B/00309 and still capable of controlling a pest or a pathogen in a plant.

35. The method of claim 20, wherein said agriculturally active formulation further comprises an agricultural compatible excipient.

36. The method of claim 20, wherein said pathogens are selected from pathogens belonging to Phytophthora infestans; Barley yellow dwarf virus; Xanthomonas sp. (campestris), Pseudomonas syringae, Rhizobium sp.; Tilletia tritici, Claviceps purpurea, Oculimacula spp., Fusarium sp., Phytium sp., Erysiphe graminis, Puccinia graminis, Puccinia triticina, Puccinia striiformis, Pyrenophora tritici-repentis, Ramularia sp. (collo-cygni), Sclerotinia sclerotiorum, Botrytis cinerea, Rhizoctonia solani, Colletotrichum graminicola, Microdochium nivale, Gaeumannomyces graminis var. tritici, Tapesia sp., Thysanoptera, Ustilago spp. or Mycosphaerella spp.

37. The method of claim 20, wherein said pests are selected from pests belonging to Rhopalosuphum padi, Diuraphis noxia, Sitobion avenae, Mythimna unipunctata, Spodoptera praefica, Euschistus spp., Aeolus spp., Anchastus spp., Melanotus spp., Limonius spp., Lepidoptera, Orthoptera, Coleoptera or Hemiptera.

38. The method of claim 20, wherein said plants are chosen from Acer spp., Actinidia spp., Abelmoschus spp., Agave sisalana, Agropyron spp., Agrostis stolonifera, Allium spp., Amaranthus spp., Ammophila arenaria, Ananas comosus, Annona spp., Apium graveolens, Arachis spp., Artocarpus spp., Asparagus officinalis, Avena spp., Averrhoa carambola, Bambusa sp., Benincasa hispida, Bertholletia excelsea, Beta vulgaris, Brassica spp., Cadaba farinosa, Camellia sinensis, Canna indica, Cannabis sativa, Capsicum spp., Carex elata, Carica papaya, Carissa macrocarpa, Carya spp., Carthamus tinctorius, Castanea spp., Ceiba pentandra, Cichorium endivia, Cinnamomum spp., Citrullus lanatus, Citrus spp., Cocos spp., Coffea spp., Colocasia esculenta, Cola spp., Corchorus sp., Coriandrum sativum, Corylus spp., Crataegus spp., Crocus sativus, Cucurbita spp., Cucumis spp., Cynara spp., Daucus carota, Desmodium spp., Dimocarpus longan, Dioscorea spp., Diospyros spp., Echinochloa spp., Elaeis sp., Eleusine coracana, Eragrostis tef, Erianthus sp., Eriobotrya japonica, Eucalyptus sp., Eugenia uniflora, Fagopyrum spp., Fagus spp., Festuca arundinacea, Ficus carica, Fortunella spp., Fragaria spp., Ginkgo biloba, Glycine spp., Gossypium hirsutum, Helianthus spp., Hemerocallis fulva, Hibiscus spp., Hordeum spp., Ipomoea batatas, Juglans spp., Lactuca sativa, Lathyrus spp., Lens culinaris, Linum usitatissimum, Litchi chinensis, Lotus spp., Luffa acutangula, Lupinus spp., Luzula sylvatica, Lycopersicon spp., Macrotyloma spp., Malus spp., Malpighia emarginata, Mammea americana, Mangifera indica, Manihot spp., Manilkara zapota, Medicago sativa, Melilotus spp., Mentha spp., Miscanthus sinensis, Momordica spp., Morus nigra, Musa spp., Nicotiana spp., Olea spp., Opuntia spp., Ornithopus spp., Oryza spp., Panicum miliaceum, Panicum virgatum, Passiflora edulis, Pastinaca sativa, Pennisetum sp., Persea spp., Petroselinum crispum, Phalaris arundinacea, Phaseolus spp., Phleum pratense, Phoenix spp., Phragmites australis, Physalis spp., Pinus spp., Pistacia vera, Pisum spp., Poa spp., Populus spp., Prosopis spp., Prunus spp., Psidium spp., Punica granatum, Pyrus communis, Quercus spp., Raphanus sativus, Rheum rhabarbarum, Ribes spp., Ricinus communis, Rubus spp., Saccharum spp., Salix sp., Sambucus spp., Secale cereale, Sesamum spp., Sinapis sp., Solanum spp., Sorghum bicolor, Spinacia spp., Syzygium spp., Tagetes spp., Tamarindus indica, Theobroma cacao, Trifolium spp., Tripsacum dactyloides, Triticosecale rimpaui, Triticum spp., Tropaeolum minus, Tropaeolum majus, Vaccinium spp., Vicia spp., Vigna spp., Viola odorata, Vitis spp., Zea mays, Zizania palustris, Ziziphus spp.; or progenies thereof or hybrids between the above.

39. The method of claim 24, wherein said bacterial strain produces albofungin and said bacterial strain comprises in its genomic DNA gene sequences having a sequence according to SEQ ID NO: 9 to 12.

40. The method of claim 24, wherein said bacterial strain comprises in its genomic DNA at least one sequence that is at least 95% identical to a sequence chosen from SEQ ID NO: 15 to 19.

41. The method of claim 24, wherein said bacterial strain comprises in its genomic DNA at least one sequence that is at least 95% identical to a sequence chosen from SEQ ID NO: 13 to 14.

42. The method of claim 24, wherein a reference of said bacterial strain is deposited with the Polish Collection of Microorganisms, respectively as Deposit ID: B/00234, B/00233, B/00235 or B/00309; is a strain that is a mutant of a strain deposited under B/00234, B/00233, B/00235 or B/00309, said mutant is still capable of controlling a pest or a pathogen in a plant; or is a strain with at least 98% genomic sequence identity with the bacterial strain as deposited as Deposit ID: B/00234, B/00233, B/00235 or B/00309 and still capable of controlling a pest or a pathogen in a plant.

43. The method of claim 24, wherein said pathogens are selected from pathogens belonging to Phytophthora infestans; Barley yellow dwarf virus; Xanthomonas sp. (campestris), Pseudomonas syringae, Rhizobium sp.; Tilletia tritici, Claviceps purpurea, Oculimacula spp., Fusarium sp., Phytium sp., Erysiphe graminis, Puccinia graminis, Puccinia triticina, Puccinia striiformis, Pyrenophora tritici-repentis, Ramularia sp. (collo-cygni), Sclerotinia sclerotiorum, Botrytis cinerea, Rhizoctonia solani, Colletotrichum graminicola, Microdochium nivale, Gaeumannomyces graminis var. tritici, Tapesia sp., Thysanoptera, Ustilago spp. or Mycosphaerella spp.

44. The method of claim 24, wherein said pests are selected from pests belonging to Rhopalosuphum padi, Diuraphis noxia, Sitobion avenae, Mythimna unipunctata, Spodoptera praefica, Euschistus spp., Aeolus spp., Anchastus spp., Melanotus spp., Limonius spp., Lepidoptera, Orthoptera, Coleoptera or Hemiptera.

45. The method of claim 24, wherein said plants are chosen from Acer spp., Actinidia spp., Abelmoschus spp., Agave sisalana, Agropyron spp., Agrostis stolonifera, Allium spp., Amaranthus spp., Ammophila arenaria, Ananas comosus, Annona spp., Apium graveolens, Arachis spp., Artocarpus spp., Asparagus officinalis, Avena spp., Averrhoa carambola, Bambusa sp., Benincasa hispida, Bertholletia excelsea, Beta vulgaris, Brassica spp., Cadaba farinosa, Camellia sinensis, Canna indica, Cannabis sativa, Capsicum spp., Carex elata, Carica papaya, Carissa macrocarpa, Carya spp., Carthamus tinctorius, Castanea spp., Ceiba pentandra, Cichorium endivia, Cinnamomum spp., Citrullus lanatus, Citrus spp., Cocos spp., Coffea spp., Colocasia esculenta, Cola spp., Corchorus sp., Coriandrum sativum, Corylus spp., Crataegus spp., Crocus sativus, Cucurbita spp., Cucumis spp., Cynara spp., Daucus carota, Desmodium spp., Dimocarpus longan, Dioscorea spp., Diospyros spp., Echinochloa spp., Elaeis sp., Eleusine coracana, Eragrostis tef, Erianthus sp., Eriobotrya japonica, Eucalyptus sp., Eugenia uniflora, Fagopyrum spp., Fagus spp., Festuca arundinacea, Ficus carica, Fortunella spp., Fragaria spp., Ginkgo biloba, Glycine spp., Gossypium hirsutum, Helianthus spp., Hemerocallis fulva, Hibiscus spp., Hordeum spp., Ipomoea batatas, Juglans spp., Lactuca sativa, Lathyrus spp., Lens culinaris, Linum usitatissimum, Litchi chinensis, Lotus spp., Luffa acutangula, Lupinus spp., Luzula sylvatica, Lycopersicon spp., Macrotyloma spp., Malus spp., Malpighia emarginata, Mammea americana, Mangifera indica, Manihot spp., Manilkara zapota, Medicago sativa, Melilotus spp., Mentha spp., Miscanthus sinensis, Momordica spp., Morus nigra, Musa spp., Nicotiana spp., Olea spp., Opuntia spp., Ornithopus spp., Oryza spp., Panicum miliaceum, Panicum virgatum, Passiflora edulis, Pastinaca sativa, Pennisetum sp., Persea spp., Petroselinum crispum, Phalaris arundinacea, Phaseolus spp., Phleum pratense, Phoenix spp., Phragmites australis, Physalis spp., Pinus spp., Pistacia vera, Pisum spp., Poa spp., Populus spp., Prosopis spp., Prunus spp., Psidium spp., Punica granatum, Pyrus communis, Quercus spp., Raphanus sativus, Rheum rhabarbarum, Ribes spp., Ricinus communis, Rubus spp., Saccharum spp., Salix sp., Sambucus spp., Secale cereale, Sesamum spp., Sinapis sp., Solanum spp., Sorghum bicolor, Spinacia spp., Syzygium spp., Tagetes spp., Tamarindus indica, Theobroma cacao, Trifolium spp., Tripsacum dactyloides, Triticosecale rimpaui, Triticum spp., Tropaeolum minus, Tropaeolum majus, Vaccinium spp., Vicia spp., Vigna spp., Viola odorata, Vitis spp., Zea mays, Zizania palustris, Ziziphus spp.; or progenies thereof or hybrids between the above.


SEQUENCE LISTING (19 sequences)

SEQ ID NO: 1 - DNA, 1525 bp, Unknown
  Bacteria
cacggagagtttgatcctggctcaggacgaacgctggcggcgtgcttaacacatgcaagtcgaacgatgaagcccttcggggtggattagtggcgaacgggtgagtaacacgtgggcaatctgccctgcactctgggacaagccctggaaacggggtctaataccggatatgacacacgaccgcatggtctgtgtgtggaaagctccggcggtgcaggatgagcccgcggcctatcagcttgttggtggggtaatggcctaccaaggcgacgacgggtagccggcctgagagggcgaccggccacactgggactgagacacggcccagactcctacgggaggcagcagtggggaatattgcacaatgggcgaaagcctgatgcagcgacgccgcgtgagggatgacggccttcgggttgtaaacctctttcagcagggaagaagcgcaagtgacggtacctgcagaagaagcgccggctaactacgtgccagcagccgcggtaatacgtagggcgcaagcgttgtccggaattattgggcgtaaagagctcgtaggcggcttgtcacgtcggatgtgaaagcccggggcttaaccccgggtctgcattcgatacgggcaggctagagttcggtaggggagatcggaattcctggtgtagcggtgaaatgcgcagatatcaggaggaacaccggtggcgaaggcggatctctgggccgatactgacgctgaggagcgaaagcgtggggagcgaacaggattagataccctggtagtccacgccgtaaacgttgggaactaggtgtgggcgacattccacgtcgtccgtgccgcagctaacgcattaagttccccgcctggggagtacggccgcaaggctaaaactcaaaggaattgacgggggcccgcacaagcagcggagcatgtggcttaattcgacgcaacgcgaagaaccttaccaaggcttgacatacaccggaaacgtctggagacaggcgcccccttgtggtcggtgtacaggtggtgcatggctgtcgtcagctcgtgtcgtgagatgttgggttaagtcccgcaacgagcgcaacccttgttctgtgttgccagcatgcccttcggggtgatggggactcacaggagactgccggggtcaactcggaggaaggtggggacgacgtcaagtcatcatgccccttatgtcttgggctgcacacgtgctacaatggtcggtacaatgagctgcgataccgcgaggtggagcgaatctcaaaaagccgatctcagttcggattggggtctgcaactcgaccccatgaagttggagttgctagtaatcgcagatcagcattgctgcggtgaatacgttcccgggccttgtacacaccgcccgtcacgtcacgaaagtcggtaacacccgaagccggtggcccaaccccttgtgggagggaatcgtcgaaggtgggactggcgattgggacgaagtcgtaacaaggtagccgtaccggaaggtgcggctggatcacctccttt

SEQ ID NO: 2 - DNA, 1527 bp, Unknown
  Bacteria
cacggagagtttgatcctggctcaggacgaacgctggcggcgtgcttaacacatgcaagtcgaacgatgaacctccttcgggaggggattagtggcgaacgggtgagtaacacgtgggcaatctgccctgcactctgggacaagccctggaaacggggtctaataccggatatgacacacgaccgcatggtctgtgtgtggaaagctccggcggtgcaggatgagcccgcggcctatcagcttgttggtggggtaatggcctaccaaggcgacgacgggtagccggcctgagagggcgaccggccacactgggactgagacacggcccagactcctacgggaggcagcagtggggaatattgcacaatgggcgaaagcctgatgcagcgacgccgcgtgagggatgacggccttcgggttgtaaacctctttcagcagggaagaagcgcaagtgacggtacctgcagaagaagcgccggctaactacgtgccagcagccgcggtaatacgtagggcgcaagcgttgtccggaattattgggcgtaaagagctcgtaggcggcttgtcacgtcggatgtgaaagcccggggcttaaccccgggtctgcattcgatacgggcaggctagagttcggtaggggagatcggaattcctggtgtagcggtgaaatgcgcagatatcaggaggaacaccggtggcgaaggcggatctctgggccgatactgacgctgaggagcgaaagcgtggggagcgaacaggattagataccctggtagtccacgccgtaaacgttgggaactaggtgtgggcgacattccacgtcgtccgtgccgcagctaacgcattaagttccccgcctggggagtacggccgcaaggctaaaactcaaaggaattgacgggggcccgcacaagcagcggagcatgtggcttaattcgacgcaacgcgaagaaccttaccaaggcttgacatacaccggaaacgtctggagacaggcgcccccttgtggtcggtgtacaggtggtgcatggctgtcgtcagctcgtgtcgtgagatgttgggttaagtcccgcaacgagcgcaacccttgttctgtgttgccagcatgcccttcggggtgatggggactcacaggagactgccggggtcaactcggaggaaggtggggacgacgtcaagtcatcatgccccttatgtcttgggctgcacacgtgctacaatggtcggtacaatgagctgcgataccgcgaggtggagcgaatctcaaaaagccgatctcagttcggattggggtctgcaactcgaccccatgaagttggagttgctagtaatcgcagatcagcattgctgcggtgaatacgttcccgggccttgtacacaccgcccgtcacgtcacgaaagtcggtaacacccgaagccggtggcccaaccccttgtgggagggaatcgtcgaaggtgggactggcgattgggacgaagtcgtaacaaggtagccgtaccggaaggtgcggctggatcacctccttt

SEQ ID NO: 3 - DNA, 594 bp, Unknown
  Bacteria
atgtcgaagaacccccagaaggattcaccacccggggagttaccggacgcgctgcacgtcctccgcacccgcagcgtcgtccgcaactacgcgcccgagccggtcgacgactccgtgatcgaccagctgctcgacgccatgctcgcggcgccctccgcctccaacaagcaggcctggtccttcgtcgtcgtacgtgatccggcgtccgtgcggcgcctgcgggccttctcccccggcatcatcgggacccccgcgttctgcgtcctcgcctgcgtcgaccagagcctgacgaagcatcactctccggcggccgcggagaacatccacgccaccagcaagctctgtgtggccatggcggtggagaacctgctcctcgccgcgcgcgccgtcggcctgggcggatgccccgtgcacagcttccgcaaggacgcggtcggcgcgctgctcggccttcccgagcacatcgagccggtgctgatcgtgccgatcggccggcccgcgagcccgcccaccccctccgaacgccgcgacaagaaggaggtcgtcagccatgaagtctggggaaaccactccgccacgaccccggccgtctga

SEQ ID NO: 4 - DNA, 678 bp, Unknown
  Bacteria
gtggctgcacgacctcttcatgaaatcgtcgaacccggctgggccaaggcacttgagccggtcgccgggcagatcgccagaatgggcgagttcctgcgggcggagatcgccgcggggcgtacctatctcccggcgggcagcaatgtgctgcgcgccttccaacagcccttcgacgacgtccgggtgctcatcgtcgggcaggatccgtatccgacgcccggtcacgcggtgggcctgagtttctccgtcgcgccggacgtccgcccgctgcccgggagtctggagaacatctaccgcgagatggcctccgacctcgggctgccgcggccgtccaacggcgatctgacgccgtggacgcggcagggcgtcctgctgctcaacagggcgctgacgacggcgccgcgcaaaccggcggcgcaccgcggcaagggctgggaggaggtcacggagcaggccatccgggccctggtcgcccggggccgtccgatggtgtcggtgctgtggggccgcgacgcgcgcaatctgcggccgctcctcggcgacctgccctcggtggagtccgcgcacccctcccccatgtcggccgaccgggggttcttcggctcgcgcccgttcagccggaccaacgacctgctggtgcggcagggcgcacagccggtggactggagactgccctga

SEQ ID NO: 5 - DNA, 270 bp, Unknown
  Bacteria
atgggaatcatcgcgtggatcctgatcgggttgctggcaggtgcgatcgcgaaggcactgatgccgggtaaggacccgggtggatgcctcgtcaccatgctgatcggcatcgtcggcggtctgctgggcggctggctcggcaaggtgatcttcggggtggagtcgatcaacggcttcttccacctgtcgacgtggatcgcggccatcatcgggtcggtgatcgtcctggtgatctaccgcgtgaccatcggccgtaaccaacggcactga

SEQ ID NO: 6 - DNA, 240 bp, Unknown
  Bacteria
atgtcgcgtgccatcaagactgccgtcgccgccgcgggaacctgcgccatcatcctgggcggcgcgagcctcgcgactgccgactccggggcccagggcgcggcgctgaactcgcccggcgtgatctccggcaacaccgtgcaggttccggtccacgtgccggtcaacgcctgcggcaacaccatcaacgtcatcggcctgctcaacccggccttcggcaacacctgcgtcaacgactga

SEQ ID NO: 7 - DNA, 690 bp, Unknown
  Bacteria
atggctgtcaaggaatcccccgaagccgccgaggccgtactcaaccgggcgatggagggcgacgacctgcccgactcgttcaccctgctcggccgggagtgggacctgcaccgcgacgtgttccccggcaccatcaccgcggcgaccgaggtgatggcctctgccctgccgtacccggagggcggctcgttcctggaggtgggctgcggcacgggggtcatctccgtcaccgccgcgctctccgggtgcgcgcaggtcaccgcgctggacatcaacgagaaggcggtggccaacaccgaggccaacgcgcgccggcaccaggtcgccgacaaggtacgcgccctgcacagtgacctgtacgacgccctggcccccgaggaccgcttcgacgcgatcttctggaacgtaccgtggacgttcgtggaggacgacttcagcctcaagagccacctgcatcacgccgtgttcgacccgggctacaagggccaggcccgctacctggccggggcgcgcgaccatctggccgacggcgggcggctgttcatcggcaccgccgacctcggggaccgcgagatgctcgaccggttcgccgaggacgccggcatgcgggtggagctgctgcgccgcatccgtcgtatcgaggtggtgcgggtcatggagtaccacctgctggagctgcaccagaagtag

SEQ ID NO: 8 - DNA, 666 bp, Unknown
  Bacteria
atgcagcaccgaacccgacgtgccggcaggaccggccgcccgccccggctggcgcgcgaagcgatcctgtccgccgcccagcgcatcctggacgaggagggcgcggagaacctctccatgcgccgtctcgccaaggagatgtccagcacgcccatggccctgtaccactacgtacgggacaaggacgagctgctgctgctcctcctggaggagcacgccgcgaagttcccccggcccgagctgccggccgagccgcgcgcccggctcctcgccgccgcccaggtcctgcacgacatcctggtggactgcccgtggatcgtcgaagtcctcgcctccgacgacctcttcgccgtctcggccatgtggatcgtcgaaaacatcctggacgccgccatcgagtgcgggatgacccccgaggacgccgtctacgcctaccgcgtcatctggtactacaccgccggtgaactgaccgtccgcttcaaccgcgagcgccgcctggcacacctggaccggccgccgcaccgcgaccagatcaccggcctggaccccggggagttcccgctcatcacctcgctgggcccccgctggaacgagctgaccgtccgggacacccaccgccgggggctggaggcggtcgtcgagggactgctggcccaggcgacctga

SEQ ID NO: 9 - DNA, 765 bp, Unknown
  Bacteria
atggatctgaagctgcagggcaagcgggccgtcgtcacgggtgccggacgcggcatcggcctggccgtcgcccgggcactcaccgcggaaggagcgcacgtcatgggaggcacgcgcagcgagagcgccgccctgcgcgacgtcaccccgcacaccatggaagtggacctcgccaccccggacggaccggcccgcctggtcggccacgccgtcgacaccttcggcggcctggacatcctggtcaacaacgtcggcggccgcaccacacctgccaccggcttcctggacctggccgacgaggactggcgggccagcttcgatctcaacctcctgagcaccgtacgggccgtgcggacggccctgcccgccctgctggagagccggggcgccatcgtcaacatcggctcggtcaacgcacaactgccgctgccgttcctcaccgagtacggcgcgatgaaggccgccctggccaatctggccaaggcgctctccgaggagttcggcccgcggggcgtacgcgtgaacaccgtctcgccgggaccggtcctcaccgacgcgtggaccaacccgcaccgcctggaacgtccggaccccggtaccgaggagcggctggccgcggtccccggccggatgcgcctgaccacgggggccttcatcgacccggaggaggtcgccgcgatggtcgtcctcctggcctcccgacgcctcccgggcgccacgggcggcgactggctcatcgacgccgggatgctcaagtccctctaa

SEQ ID NO: 10 - DNA, 312 bp, Unknown
  Bacteria
gtgcccggtgaggcgcgggtcatcgtctaccaggccgcgtacgacgaggcgcagctcgacgcggtccgggccgcctaccaccaggtcagcgagcggatggcgaaggtgccggggctgctcggcaacgagctgctgcgcagccccgcggaccccaccgcgctcgcggtgatgagccgctgggagtccctggccgccttcctggagtgggagaagggcgcggaccaccgccaggacaccgcgccgctgcgcccgttccgcgacaccaggaccgccgcgccgttcgccgtgtacgaggtcgacgccgcgtactga

SEQ ID NO: 11 - DNA, 753 bp, Unknown
  Bacteria
atggatctgggcttgcaggacaagcgggttctggtgaccggcgcgacgcgcggcatcggcagggccgccgcgaaggccttcgccgccgagggcgcccgggtgatcgtcacgtaccacaccggcgagtccgccgcgaaggccgtggtggaggagctgggcggcgccgagcgcgcccacgccgtccgcctggacctcggcgacccggagtccgtgaccgccggcgtccgggccgccgaggaccgctggggcgggatcgacgtggtcgtcgccaacgcccagacatgggtgtgggtcgaccccgaccagcagccgccgctggaggacctgccgaccgacgagtggttcggcaagatgcgcgccaacgtcgaggggcacatcctcaccgtccggcaggccctgcgcggcatgcgcgagcgtggctgggggcgggtcgtgctgctctcctcggtcaccgcgaccgcgggcatgccgggatccgagatctacagcgccgccaagtcggcgctgcacggcttcgcccgcggcctgatgtggaaccacgacggcatcctcgtcaacgtggtggcccccggcggcacgatcaccgaacagctcgccggcgtggacccggcggtcatcgagaagagcgccggggagacccccagcgggcggctgaccaccgcggaggaggtcgcgcgcctcatcgtcttcctgggttcggacggcaacggcaacgtcaatggcgaggtcgtccacaccgccggcggacgctga

SEQ ID NO: 12 - DNA, 270 bp, Unknown
  Bacteria
atgagcgacatctcactggccgaactcaacgaactgctgctggagtgcgtcggggcaccggaggagggcatgagcctcgacggtgacgacgccctcgacaccccgttcctggagttcggctacgactccctggccctgctccaggtcacgggcgtcatcgagcgccgccacggcatcgcgctgaacgacgacgcggtggccgaggccgtgacgccgcgcctgctgctggacctcgtcaaggaagcgccgcgcgccggggcggcccggtga

SEQ ID NO: 13 - DNA, 423 bp, Unknown
  Bacteria
gtgaacgctcacccggaaacgcctgacatctggaccgcggacgacggttcggaagtaatatgtctgcgtcgttggaaaggcagctgggactcggacgaccggcatgcgaacttcaagtcggacgttctcgcctacggactgctcgacccgctggagacggtgcgcggcatgtcccgcaacctggacatccccgtcggcgccatcgtgcggtacgtgctcgccaaatgggccactggagggagcggcggtctcctggagatcgggccggtgatggtgccccggctgtgggagccgatcgcggcggcggaggagaaggacgacgacgaggaacggctccgggcgtaccaccaactgcgccagatgatctcgtggttgaaggtcccgctggacgaccccacggtgtatccgccgcaacgcgactga

SEQ ID NO: 14 - DNA, 732 bp, Unknown
  Bacteria
atggcggtcccgccgtccgacggccggtcgtcccgagtcgccggtgcgacccacctcgcggctctgcggccccccaccgaccggggcgacaggcccgccggtacggagcggagcacggacccggtgagcgtggtcgtgctggcggacgaccccatcaccctcgacggcacggtcgccttcttgcggagcaacccgctgatctcggtcgtcggcgacgaccggctgcgggaggcggacgtcgtcctgatcctggtgtcgcccgaggggaccgacgaggcgctcgcccggctggggcagcgggacgcctggcaacggccctcccagcggctgatcctggtcgcggactcgatgtcggagtaccagctgatgcgcgccgtggcgcacggcctgacggacgtactgccgcgggcccagagcgatctgggcgcgatcgcggacgccgtctgcgaccgccggcagcgcaccggggtggccgattcgctggtcacgctgctgcaccatctccagcgcgacatcctggagccgcaccggctgaacgcggccggcttcgacacgcgggagatgaacatcctgcggatgctcgccgacggctggagcaccggcgaggtggccaaggaactcgggtactccgagcgcaccatcaagaacgcgatccatacgatgctggccaggctgggactgcgcaaccgcacacacgccgttgcccatgccatccgttccggcacggtctga

SEQ ID NO: 15 - DNA, 744 bp, Unknown
  Bacteria
atgcatcgagctgctggacgagctcagcagggactggccggtcgccggcgcgcggctcacgaagaatccgcccgcggcacgtcgcgcttggcgatacacgggacgccgacggcacccaagaatacgatcgccgatggctgcggatcctggctcggacaagattttcttgcagccggcgatcgacaggtcgatccgtaccggagggccgccgaccacctcgtcctcgacatgccgcacgtaccggctgtgcccccagtcggagaggtcaccacagcagcccgtgcacgcggccggtcctgcctcggggccgcgcggagatcaccaccgtgccccccgcactcctcgaccgaactgatctccacagcggcagcatcccgccggatcagccggatctcacgtctcgacggaatcgatcagcgactacgaaaatcgtgcctgagccggaatccacaccctcccgccttcggccggcaagcccttggcctgggccgcagccagaatcgtatcgagcaccgccggtcggcgtccgcctcgatcaggcggtcccggaaacgcgagcgtgcccccggggaaggccgcccggacaacccgcaccgtctcggcagggctctcccccgcccccgtcggccgcatcgacatcgctgcccctcctgcaccacgacgccggcctccgagacggagtccccggggccgacggcaccagggggccaggacatccgagtggacgaacgggagggcggctga

SEQ ID NO: 16 - DNA, 348 bp, Unknown
  Bacteria
gtgttcgacctcagggccgaggcggaaatgcgcctcttctcggagaaactggccagggaactcgccgggaagcgtgccagcgcgcaggggaacgcgggcgaccgcgccgcgacggattctccagcggacgggcggaagcccccggacacggcggacgcgccgtccacctcggagataccgatggccgcggaggtgccgggggccgcggaggtgccgggtgtgatgaaggcgccgggcgcagtgaaggtcccggatgcgttgggtccaccggacgtcgcgaaagcgccgggcgccgtggaggcatcggacgcggcgagcgcaagggggccccttcccgccggttcgtga

SEQ ID NO: 17 - DNA, 1074 bp, Unknown
  Bacteria
atggcgcgcggattccgcatactcccagctcaggcggccgccaagacacgttgcgccgactcgccgaaggttcgcgggcgccctagcgtggccgtcatggatgtcgagctgtgggccactgtgcagccgatgccaggggttcgcgaagcctgcgagctggaggcggccggctgggacggtgtcacgttcggggactcccagtgcctcatgggcgatgcctacatcgccttgagcgccgcagcactgaccaccaacaacatccgtctggggatcggcgtcacgaatccctggacccggcaccccgctgtcaccgccgctgccgtcatgtccgcccacatcgagtcccgccagcgcgtcaccttgggcatcggtcggggagacagctccctgacccagctcggactcgatcccgtacccgtctcccagctcgtttcctacaccaccagcgtgcagacgtatctccgtggcgaggccgtacctcctccgaacccgaacccgaacccgaacccgcagaacccctcgggcgacgcgtcacggccgttcaaccaccgccttgccgcgctccccggaggcagccgcttgaactggctcgaccgtacgaccggcgtggtgaaaccggaggtgttcgtcgcggcttccggaccccgcgtcatacgggccgccactgccacggccgatgtgacagccctgactgtcggcgccgatccggaccggctgcgacaggccgccgcggtggcccgagagacgaagccggacgtgcggctggccgcattcatccatgtcgtcgtggacgacgacacagaccgggcccgtgccatgtcggcagacagcgtcgttcgcttcgcccgtttttcgccctgtcccggcagcgacccgacgccggatttcctcgacaccttcgccgtcctcggcccggcgtcccactgcctggaacggctgctggaactggcggaaatcggcatcgaacgtttccacgtcgtcgccggatgcacgggcgactaccgcaaacgctcgtacggggccttcgcccgtgacgtcattccggctcttcgcgagcacgccgcccgcgcttga

SEQ ID NO: 18 - DNA, 1071 bp, Unknown
  Bacteria
atgcgccgggaccgcgaccgcaggtggctgctgttcgcgctgctcctgggcgtccccatagccgccggtgatctcgcactgggtacaccgcacagcgtggccgggctgctgatgatctgtacgctgctggccgtcacccggctcgacggcccctgtaccggctccgtcgccctgtacgtggtgctgctggccgccggtgtcgcggtgtgggagggcgagctcggcgaacgggacgtgctgatacgcctgaccgtgctcgcgctgggcggcgcgtacgccacctggagcgccgcccggcgggtggcccacgaaggcgagctgaccgaggcctcgtccgtcgcccagcgcgccatcctccagcccaccaccttccggctcggcggtgtgaccgtgtgcgcccgctaccgctccgcctcgccgcaggccctgctcggcggagatctgtacgccttcgcgcacaccgccgccggcctgcgcctgctgatcggcgacgtccggggcaacggcctgcgggccgtacgcctgtcggccgccgtgatcagcttcttccgggacagtgcctacacccgccccgacctgcccgccgtgctcgacgccaccgaccggcgcctggccgcgctgctcggcgcggaggacttcgtcaccgccctggcggccgagttccgcaccaccggccggcccgccgtcacccgggtcggcctggccaactgcggccaccacccgcccctgctcctgcccgccgacgccccgccgcgcctgctcgctccggccgaaccgaccacccccctgggactgcaccccgcgccggtcgtccaggacgtgatcctcggccccggcgaccgcctgctgttctacaccgacggcctggccgaggcccgcagcgccgagggcgagatggtcgatctcgccggcctgcggtccgcctgctcgcgggcggcgctggacgacgccgccgacgcggtgcaggaggccctgctccgccacacggacggcgccctcgacgacgacgtggcgttcatcctggtcgagtcctgcccgccggcgcgctcaccggacgtccgggccgggtga

SEQ ID NO: 19 - DNA, 624 bp, Unknown
  Bacteria
atgtcgatccctgcaataggcgagaaggcgttgctgtcccaggagcaggtctgttccctgctcgggtgggtgcgggacaaaactgccagcgatgaggcggtctacccgttcttggtctcgctggccgcggctgccctggccccgaacgaagcaggtgcccttcgagtgggcgacgtgacactggcggagagcggctgtggcgagatgcggatccttgcccgacgcgccaggacggtgcccgtcacaccagagctcgccgggctgctgcggagttggatcaatagcgctggtctgaagccggacgacctgttgttccccggtaagcgtggtgggccgctgccggctgtggcgtatcggcgtgtatggcggcgggcgcgcgagtcggtcctgcagccggacgagagggcggctcgcctggcggagcatgtctccagcctgcgcgaacactgccttgttacgtggctcaagaggggcgttcctgtctggggcgtcgccgagtgggccggcgtgagcccgagctggcttgcgctgcgctacccgcactgctttcggctggaggacgtcgagctcgactgggaccacctgaccgaagccatggcgcttccggactcgctcaaacgatga